(19) United States
(12) Patent Application Publication
(10) Pub. No.: US 2025/0236991 A1
(43) Pub. Date: Jul. 24, 2025

(54) METHOD OF FORMING A FIBER, A FIBER, AND AN ARTICLE COMPRISING ONE OR MORE STRANDS OF FIBERS

(71) Applicant: National University of Singapore, Singapore (SG)

(72) Inventors: Songlin ZHANG, Singapore (SG); Swee Ching TAN, Singapore (SG)

(21) Appl. No.: 18/671,300

(22) Filed: May 22, 2024

(30) Foreign Application Priority Data
Jan. 23, 2024 (SG) 10202400199Y

(51) Int. Cl. D01F 1/09; C08J 3/11; C08J 3/24; D01D 1/02; D01D 5/04; D01F 6/18

(52) U.S. Cl. CPC D01F 1/09; C08J 3/11; C08J 3/24; D01D 1/02; D01D 5/04; D01F 6/18; C08J 2333/20; D10B 2321/10; D10B 2401/063; D10B 2401/16

(57) ABSTRACT

There is provided a method of forming a fiber, the method comprising preparing a dope comprising a metal ion coordination polymer; and forming a precursor fiber from the dope in air, wherein the precursor fiber undergoes a phase transition from a liquid or semi-liquid state to the fiber in a solid state in air. There is also provided a fiber comprising a metal ion coordination polymer, said metal ion coordination polymer comprising, a plurality of metal ions acting as nodes; and a plurality of organic ligands acting as linkers, wherein the metal ions are linked to the organic ligands via coordination bonds to form a network structure of the metal ion coordination polymer. There is further provided an article comprising one or more strands of fibers formed by the method as disclosed herein, or one or more strands of fibers as disclosed herein.

### CROSS-REFERENCE TO RELATED APPLICATIONS

This application claims priority to SG Patent Application No. 10202400199Y, filed Jan. 23, 2024, which is incorporated by reference herein in its entirety.

### TECHNICAL FIELD

The present disclosure relates broadly to a method of forming a fiber, a fiber, and an article comprising one or more strands of fibers.

### BACKGROUND

Functional soft fiber materials are in high demand for various engineering applications, ranging from biomedical devices to wearable electronics for healthcare to functional components for soft robotics. The evolution of soft fibers can expedite electronic textile development for a myriad of applications such as healthcare, sports, and human-machine interface. However, producing one-dimensional (1D) fibers with seamless integration of all-around functionalities is much more difficult than their two-dimensional (2D) film or three-dimensional (3D) monolith counterparts.

Current spinning techniques to produce functional soft fibers include dry spinning, wet spinning, electrospinning, microfluidic spinning, thermal drawing, and direct printing. These methods are undermined by their complicated fabrication processes, e.g., multistep post-treatment processes, high energy consumption/input and use of large quantities of solvent, e.g., organic solvent, and/or special spinning equipment and conditions, which are environmentally and economically costly. In addition, these methods are not efficient for fabrications of 1D functional soft fibers under ambient conditions with simultaneously unified mechanical and electrical functionalities. For instance, thermal drawing requires high energy input and multistep treatments to endow mechanical and electrical functions. Wet spinning, however, consumes a large volume of solvents which raises concerns on environmental impact.

Thus, there is a need for a method of forming a fiber, a fiber, and an article comprising one or more strands of fibers, which seek to address or at least ameliorate one of the above problems.

### SUMMARY

In one aspect, there is provided a method of forming a fiber, the method comprising preparing a dope comprising a metal ion coordination polymer; and forming a precursor fiber from the dope in air, wherein the precursor fiber undergoes a phase transition from a liquid or semi-liquid state to the fiber in a solid state in air.

In one embodiment of the method, preparing the dope comprises dissolving a polymer resin and a metal ion source in a solvent to obtain a solution of the polymer resin and the metal ion source.

In one embodiment of the method, preparing the dope further comprises curing the solution of the polymer resin and the metal ion source to obtain the dope comprising the metal ion coordination polymer.

In one embodiment of the method, the solution of the polymer resin and the metal ion source is cured for a duration falling in the range of from 5 hours to 150 hours at a temperature falling in the range of from 20° C. to 90° C.

In one embodiment of the method, the solution of the polymer resin and the metal ion source is cured until the dope satisfies one or more of the following conditions:
(i) a viscosity falling in the range of from 10 Pa·s to 50 Pa·s;
(ii) a storage modulus falling in the range of from 100 Pa to 200 Pa; and
(iii) a loss modulus falling in the range of from 10 Pa to 150 Pa.

In one embodiment of the method, the polymer resin is selected from the group consisting of polyacrylonitrile, poly(methacrylic acid), sodium polyacrylate, acrylonitrile butadiene styrene, and nitrile butadiene rubber.

In one embodiment of the method, the metal ion is selected from the group consisting of silver, iron, zinc, and bismuth.

In one embodiment of the method, 5 wt. % to 20 wt. % of the polymer resin is dissolved in the solvent.

In one embodiment of the method, the metal ion source is provided by dissolving a salt of the metal ion in the solvent.

In one embodiment of the method, 2 wt. % to 20 wt. % of the salt of the metal ion is dissolved in the solvent.

In one embodiment of the method, the solvent is selected from the group consisting of dimethylformamide (DMF), N-methyl-2-pyrrolidone (NMP), a mixture of DMF-water, and a mixture of NMP-water.

In one embodiment of the method, forming the precursor fiber comprises spinning the precursor fiber from the dope.

In one embodiment of the method, the precursor fiber is formed from the dope in air having atmospheric pressure, a relative humidity falling in the range of from 40% to 95%, and a temperature falling in the range of from 20° C. to 50° C.

In one embodiment of the method, the metal ion coordination polymer in the dope comprises, a plurality of metal ions acting as nodes; and a plurality of organic ligands acting as linkers, wherein the metal ions are linked to the organic ligands via coordination bonds to form a network structure of the metal ion coordination polymer.

In one embodiment of the method, the metal ion is silver ion and the ligand is a nitrile group; and wherein the silver ions are linked to the nitrile ligands via coordination bonds to form a [Ag(N≡C—)ₓ]⁺ complex, wherein x is an integer that is no less than 1 and no more than 3.

In another aspect, there is provided a fiber comprising a metal ion coordination polymer, said metal ion coordination polymer comprising, a plurality of metal ions acting as nodes; and a plurality of organic ligands acting as linkers, wherein the metal ions are linked to the organic ligands via coordination bonds to form a network structure of the metal ion coordination polymer.

In one embodiment of the fiber, the metal ion is silver ion and the ligand is a nitrile group; and wherein the silver ions are linked to the nitrile ligands via coordination bonds to form a [Ag(N≡C—)ₓ]⁺ complex, wherein x is an integer that is no less than 1 and no more than 3.

In one embodiment, the fiber further comprises nanoparticles of the metal interspersed in the network structure of the metal ion coordination polymer.

In one embodiment, the fiber has one or more of the following properties: an axial strain of at least 500%; a tensile strength of at least 6 MPa; and an electrical conductivity of from 0.1 S/m to 100 S/m.

In another aspect, there is provided an article comprising one or more strands of fibers formed by the method as disclosed herein, or one or more strands of fibers as disclosed herein.

### Definitions

The term “humidity” as used herein is a measure of the amount of moisture or water vapor present in the air in a specific environment. Humidity is typically expressed as a percentage and is known as relative humidity (RH). Relative humidity represents the ratio of the amount of moisture in the air to the maximum amount of moisture the air can hold at a given temperature, expressed as a percentage.

The term “fiber spinning” as used herein broadly refers to a process that involves extruding a polymer solution, melt or dope through a spinneret with hole(s) or nozzle(s) into a surrounding environment (e.g., air or a coagulation bath). For example, extruding dope from a dope-filled syringe can result in fiber formation while continuously stretching and collecting the fiber on a bobbin. For example, fiber spinning may include electrospinning, wet spinning, and dry spinning. The term “fiber spinning” also broadly refers to a process that involves manually spinning a fiber from a dope, e.g., gel dope. For example, fiber may be formed by drawing a thread out of a gel dope. For example, fiber may be formed by stretching a ball of dope into a thin thread, e.g., between two tweezers, until a specific diameter and/or length of the fiber is achieved. The spun material forms fibers as it solidifies.

The term “fiber drawing” as used herein broadly refers to a process that involves elongating an existing fiber to achieve desired characteristics (e.g., strength, stiffness, and dimensional uniformity). The fiber may be pulled through a set of rollers or similar mechanisms, subjecting it to tension that stretches and elongates the fiber. The fiber drawing process may be capable of aligning polymer chains, increasing a fiber's strength and stiffness, and modifying its diameter.

The term “dope” as used herein broadly refers to a polymer solution or suspension of polymers, dissolved in a solvent or a mixture of solvents, used in fiber formation such as fiber drawing and fiber spinning.

The term “coordination polymer” or “metal ion coordination polymer” as used herein broadly refers to structures including metal cation centers linked by ligands to form a coordination complex. The presence of coordination complexes may be verified using techniques such as atomic force microscopy-based single-molecule force spectroscopy (AFM-SMFS).

The term “ligand” as used herein refers to a molecule or ion that binds to a central metal atom or ion to form a coordination complex.

The term “electrically conductive material” as used herein is to be interpreted broadly to include but not limited to both a conductive material, which is intrinsically or inherently capable of electrical conductivity, and a semiconductive material, which exhibits semiconducting properties.

The term “substrate” as used herein is to be interpreted broadly to refer to any supporting structure.

The term “layer” when used to describe a first material is to be interpreted broadly to refer to a first depth of the first material that is distinguishable from a second depth of a second material. The first material of the layer may be present as a continuous film, as discontinuous structures or as a mixture of both. The layer may also be of a substantially uniform depth throughout or varying depths. Accordingly, when the layer is formed by individual structures, the dimensions of each of individual structure may be different. The first material and the second material may be same or different and the first depth and second depth may be same or different.

The term “continuous” when used to describe a film or a layer is to be interpreted broadly to refer to a film or a layer that is substantially without gaps or holes or voids across the film or layer. In this regard, a continuous film or a continuous layer is also intended to include a film or a layer that may have trivial gaps or holes or voids that may not appreciably affect the desired properties of the film or the layer.

The term “micro” as used herein is to be interpreted broadly to include dimensions from about 1 micron to about 1000 microns.

The term “nano” as used herein is to be interpreted broadly to include dimensions less than about 1000 nm.

The term “particle” as used herein broadly refers to a discrete entity or a discrete body. The particle described herein can include an organic, an inorganic or a biological particle. The particle used described herein may also be a macro-particle that is formed by an aggregate of a plurality of sub-particles or a fragment of a small object. The particle of the present disclosure may be spherical, substantially spherical, or non-spherical, such as irregularly shaped particles or ellipsoidally shaped particles. The term “size” when used to refer to the particle broadly refers to the largest dimension of the particle. For example, when the particle is substantially spherical, the term “size” can refer to the diameter of the particle; or when the particle is substantially non-spherical, the term “size” can refer to the largest length of the particle.

The terms “coupled” or “connected” as used in this description are intended to cover both directly connected or connected through one or more intermediate means, unless otherwise stated.

The term “associated with”, used herein when referring to two elements refers to a broad relationship between the two elements. The relationship includes, but is not limited to a physical, a chemical or a biological relationship. For example, when element A is associated with element B, elements A and B may be directly or indirectly attached to each other or element A may contain element B or vice versa.

The term “adjacent” used herein when referring to two elements refers to one element being in close proximity to another element and may be but is not limited to the elements contacting each other or may further include the elements being separated by one or more further elements disposed therebetween.

The term “and/or”, e.g., “X and/or Y” is understood to mean either “X and Y” or “X or Y” and should be taken to provide explicit support for both meanings or for either meaning.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For example, when “comprising” is used, reference to a “one” feature is also intended to be a reference to “at least one” of that feature. Terms such as “consisting”, “consist”, and the like, may in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. It is to be appreciated that the individual numerical values within the range also include integers, fractions and decimals. Furthermore, whenever a range has been described, it is also intended that the range covers and teaches values of up to 2 additional decimal places or significant figures (where appropriate) from the shown numerical end points. For example, a description of a range of 1% to 5% is intended to have specifically disclosed the ranges 1.00% to 5.00% and also 1.0% to 5.0% and all their intermediate values (such as 1.01%, 1.02% . . . 4.98%, 4.99%, 5.00% and 1.1%, 1.2% . . . 4.8%, 4.9%, 5.0% etc.,) spanning the ranges. The intention of the above specific disclosure is applicable to any depth/breadth of a range.

Additionally, when describing some embodiments, the disclosure may have disclosed a method and/or process as a particular sequence of steps. However, unless otherwise required, it will be appreciated that the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Furthermore, it will be appreciated that while the present disclosure provides embodiments having one or more of the features/characteristics discussed herein, one or more of these features/characteristics may also be disclaimed in other alternative embodiments and the present disclosure provides support for such disclaimers and these associated alternative embodiments.

### DESCRIPTION OF EMBODIMENTS

Exemplary, non-limiting embodiments of a method of forming a fiber, a fiber, and an article comprising one or more strands of fibers are disclosed hereinafter.

In various embodiments, there is provided a method of forming a fiber, the method comprising preparing a dope comprising a metal ion coordination polymer; and forming a precursor fiber from the dope in air, wherein the precursor fiber undergoes a phase transition from a liquid or semi-liquid state to the fiber in a solid state in air, e.g., while being formed from the dope.

In various embodiments, the phase transition to form fiber in the solid state comprises precipitation of a solvent and water (e.g., in a form of a mixture) from the precursor fiber under ambient humidity. In various embodiments, the phase transition to the solidified fiber may occur spontaneously or autonomously while the precursor fiber is being formed (e.g., spun) from the dope. In various embodiments, the phase transition to a solidified fiber (i.e., from the precursor fiber in the liquid or semi-liquid state to the fiber in the solid state) may be facilitated by nonsolvent vapor-induced phase separation (NVIPS). In various embodiments, the step of forming (e.g., spinning, drawing, pulling, extruding) the precursor fiber from the dope in air induces NVIPS. In one embodiment, the precursor fiber is a precursor gel fiber.

In various embodiments, NVIPS occurs due to differences in vapor pressure, concentration, and solubility between the solvent used to prepare the metal ion coordination polymer (i.e., polymer solute) and a nonsolvent vapor, e.g., nonsolvent vapor of water. In various embodiments, a nonsolvent is a substance that does not dissolve the polymer solute. In various embodiments, the nonsolvent vapor may be water vapor. In various embodiments, the water vapor may be from ambient humidity. In various embodiments, NVIPS is initiated by water molecules from ambient humidity. In various embodiments, the water molecules separate the precursor fiber into an aqueous water-miscible part and a solidified water-immiscible part. In various embodiments, a continuous supply of water molecules from ambient humidity instantaneously promotes phase separation once the precursor gel fiber is drawn into air.

In various embodiments, adsorption of the nonsolvent vapor on the precursor fiber occurs during formation of the precursor fiber, thereby forming a layer comprising a mixture of the nonsolvent and the solvent on an exterior surface of the precursor fiber. This stage may be described as nonsolvent (e.g., water) inward adsorption controlled by miscibility with the solvent (e.g., DMF solvent). In various embodiments, adsorption of the nonsolvent vapor on the precursor fiber leads to changes in local concentrations of the solvent and nonsolvent. In various embodiments, the local concentration of the solvent may be lower at the exterior region as compared to a core region of the precursor fiber due to the mixture of the nonsolvent and the solvent at the exterior region. In various embodiments, the polymer solute moves inwards to the core region of the precursor fiber where there is a higher concentration of the solvent, thereby resulting in a contraction, e.g., radial contraction, of the precursor fiber. This stage may be described as solute inward contraction controlled by solubility of the polymer solute. In various embodiments, the solvent at the core region diffuses towards the exterior region of the precursor fiber due to differences in concentrations of the solvent at the core and exterior regions of the precursor fiber. This stage may be described as solvent outward diffusion controlled by concentration gradient of the solvent in the fiber radial direction.

In various embodiments, phase separation is characterized by formation of a solid phase at the core region of the precursor fiber and formation of a liquid phase at the exterior region of the precursor fiber. In various embodiments, the exterior region surrounds the core region of the precursor fiber. In various embodiments, the solid phase at the core region of the precursor fiber eventually forms the solidified fiber. In various embodiments, the liquid phase comprising a mixture of the solvent and nonsolvent at the exterior region of the precursor fiber eventually accumulates as droplets on an exterior surface of the solidified fiber.

In various embodiments therefore, the method may further comprise a step of removing or collecting the droplets on the exterior surface of the solidified fiber. In various embodiments, removing or collecting the droplets may comprise mechanically vibrating the solidified fiber. In various embodiments, removing or collecting the droplets may comprise spinning, e.g., vertically spinning the solidified fiber such that the droplets fall in a downward direction off the solidified fiber under the influence of gravity. In various embodiments, removing or collecting the droplets may comprise holding the fiber at an inclined angle or vertically such that the droplets flow in a downward direction along the fiber under the influence of gravity. In various embodiments, the solvent in the collected droplets may be recycled, thereby facilitating sustainable manufacturing with solvent recycling capability.

In various embodiments, the method may be performed under ambient conditions (e.g., 75% relative humidity (RH) at 24° C.). In various embodiments therefore, the method may advantageously overcome the limitations of existing fiber fabrication methods. Existing fiber fabrication methods are undermined by their complicated fabrication processes, high energy consumption and use of large quantities of solvent, and/or special spinning equipment, which are environmentally and economically costly. In various embodiments, the presently disclosed method may not require any thermal energy input during spinning. This is unlike a thermal fiber drawing process which involves heating a preform material to a high temperature before fiber can be drawn from the preform material. In various embodiments, the method may not require applying an electric field to the dope during spinning. This is unlike an electrospinning process which involves the creation of fibers from a polymer solution or melt by subjecting it to an electric field. In various embodiments, the method may require a relatively smaller volume of solvent compared to existing fabrication methods. In various embodiments, the method may not require solvents of organic or inorganic chemicals that are typically associated with a wet spinning process. In various embodiments, the method may not require the use of a coagulation bath, e.g., to induce precipitation and solidification of a polymer from its dissolved state in solution. For wet spinning, different coagulation baths may be used, depending on the properties of the spinning dope. Typically, the following solutions may be used as the coagulation bath: water, ethanol, dimethylacetamide, N-methylpyrrolidone, or a mixture thereof.

In various embodiments, the method may be used to form fibers that are beyond the functionalities of fibers prepared via existing spinning approaches. Existing fiber fabrication methods are not efficient for fabrications of 1D functional soft fibers under ambient conditions with simultaneously unified mechanical and electrical functionalities. For example, the integration of multiple functionalities such as mechanical softness, stretchability, and electrical conductivity into 1D fibers is challenging as these properties are difficult to achieve simultaneously. For example, most stretchable materials are not intrinsically conductive, and most conductive materials are not mechanically stretchable. In various embodiments, functional fibers prepared by the presently disclosed method may comprise one or more of the following characteristics: strength, mechanical softness, stretchability, recyclability, electrical conductivity, and displaying multimodal sensing abilities (e.g., in response to mechanical and/or thermal cues). For example, functional fibers prepared by the presently disclosed method may be stretchable and electrically conductive.

In various embodiments, the dope is a spinnable dope. In various embodiments, the dope is a spin dope. In one embodiment, the dope is a gel dope. In various embodiments, spinnability is broadly defined as the tendency to form a fiber. In various embodiments, the spinnability of a dope may depend on the properties of the dope, such as its polymer concentration and structure of its molecular chain network. In one embodiment, the dope is in a liquid, semi-liquid or gelatinous state. In various embodiments, the dope is viscoelastic. In various embodiments, the dope is stretchable, e.g., rheologically stretchable. In various embodiments, the term “rheologically stretchable” refers to the ability of a material to undergo significant deformation or stretching while substantially maintaining its rheological properties without breakup or capillary failure. In various embodiments, rheological behavior of the dope, e.g., how it responds to shear forces, may impact its processibility and ability to control fiber formation. In various embodiments therefore, the dope comprises rheological properties that are finetuned/optimized to achieve good spinnability. In various embodiments, the dope has a viscosity that allows it to flow and be processed through a fiber forming apparatus, e.g., spinning or extrusion apparatus.

In various embodiments, the dope comprises a matrix or network of the polymer crosslinked with metal ion coordination complexes. In various embodiments, the metal ion coordination polymer in the dope comprises a plurality of metal ions acting as nodes. In various embodiments, the metal ion coordination polymer further comprises a plurality of organic ligands acting as linkers. In various embodiments, the metal ions are linked to the organic ligands via coordination bonds to form a network structure, e.g., crosslinked network structure, of the metal ion coordination polymer. In various embodiments, the presence of the metal ions advantageously enables formation of a strong and dynamic supramolecular network comprising metal ion coordination complexes. In various embodiments, a supramolecular network refers to a 3D arrangement of molecules or molecular assemblies held together by non-covalent interactions, e.g., metal coordination. In various embodiments, the dope may be a polyacrylonitrile-silver ion dope.

In various embodiments, preparing the dope comprises dissolving a polymer resin and a metal ion source in a solvent to obtain a solution of the polymer resin and the metal ion source.

In various embodiments, polymer resins that are suitable for preparing the dope may be rheologically controllable or tunable. This advantageously allows the polymer resin to be formulated into a dope with controlled viscosity and rheological properties that improve its spinnability. In various embodiments, suitable polymer resins may be chemically compatible with solvents and additives used in the dope. This may advantageously facilitate the preparation of stable dopes with consistent properties. In various embodiments, the polymer resin comprises one or more functional groups for facilitating formation of the metal ion coordination polymer. Examples of such functional groups include but are not limited to nitrile, carboxylate, amine, imine, and the like.

In various embodiments, the polymer resin includes but is not limited to polyacrylonitrile, poly(methacrylic acid), sodium polyacrylate, acrylonitrile butadiene styrene, and nitrile butadiene rubber. In various embodiments, the polymer resin may have a molecular weight of from about 10,000 Da to about 150,000 Da. In various embodiments, the polymer resin may have a molecular weight falling in the range with start and end points selected from the following group of numbers: 10,000, 15,000, 20,000, 25,000, 30,000, 35,000, 40,000, 45,000, 50,000, 55,000, 60,000, 65,000, 70,000, 75,000, 80,000, 85,000, 90,000, 95,000, 100,000, 105,000, 110,000, 115,000, 120,000, 125,000, 130,000, 135,000, 140,000, 145,000, and 150,000 Da. In various embodiments, the polymer resin may comprise polyacrylonitrile. In various embodiments, the nitrile group (also known as the cyano group) in polyacrylonitrile can act as a ligand.

In various embodiments, the polymer resin is dissolved in the solvent in an amount of from about 5 wt. % to about 20 wt. % of the solution. In various embodiments, the amount of polymer resin to be dissolved in the solvent falls in the range with start and end points selected from the following group of numbers: 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, 13.9, 14, 14.1, 14.2, 14.3, 14.4, 14.5, 14.6, 14.7, 14.8, 14.9, 15, 15.1, 15.2, 15.3, 15.4, 15.5, 15.6, 15.7, 15.8, 15.9, 16, 16.1, 16.2, 16.3, 16.4, 16.5, 16.6, 16.7, 16.8, 16.9, 17, 17.1, 17.2, 17.3, 17.4, 17.5, 17.6, 17.7, 17.8, 17.9, 18, 18.1, 18.2, 18.3, 18.4, 18.5, 18.6, 18.7, 18.8, 18.9, 19, 19.1, 19.2, 19.3, 19.4, 19.5, 19.6, 19.7, 19.8, 19.9, and 20 wt. % of the solution. In various embodiments, the amount of polymer resin used is sufficiently low such that the processibility of the dope is not compromised. In various embodiments, the dope needs to flow smoothly and evenly through a spinneret or extrusion nozzle for successful spinning. Poor flow of the dope may lead to difficulties in extrusion, poor fiber formation, uneven fiber diameter, and even clogging of the spinneret. In various embodiments, the amount of polymer resin used is sufficiently high such that strong fibers can be formed from the dope. An insufficient amount of polymer resin used may result in weak fibers.

In various embodiments, metals that are suitable for use as metal ions in a metal ion coordination polymer exhibit specific characteristics that allow them to readily form stable coordination bonds with ligands. In various embodiments, suitable metals may comprise one or more available coordination sites, e.g., in partially filled d orbitals, that can form coordination bonds with ligands. In various embodiments, suitable metals may have multiple accessible oxidation states. This advantageously allows for a variety of coordination environments and potential redox properties in the coordination polymer. In various embodiments, suitable metals may be transition metals. Transition metals may be suitable due to their flexible coordination geometries and ability to form multiple coordination bonds. In various embodiments, suitable metals are compatible with the ligands used, as this ensures the formation of stable coordination bonds and the desired structural arrangement. In various embodiments, metal ions have a charge that is appropriate for the coordination geometry and ligands being used. In various embodiments, the charge of the metal ion affects its ability to attract and coordinate with ligands. In various embodiments, suitable metals should be readily available and easy to synthesize into coordination complexes for practical applications. In various embodiments, suitable metals should have low toxicity.

In various embodiments, the metal ion includes but is not limited to silver, iron, zinc, and bismuth. In various embodiments, the metal ion source is provided by dissolving a salt of the metal ion in the solvent. Examples of metal ion salts include but are not limited to silver nitrate, iron (III) chloride (FeCl₃), zinc chloride (ZnCl₂), and bismuth (III) nitrate pentahydrate (Bi(NO₃)₃·5H₂O). In various embodiments, silver nitrate may be used as the metal ion source for silver ions. In various embodiments, the salt of the metal ion is dissolved in the solvent in an amount of from about 2 wt. % to about 20 wt. % of the solution. In various embodiments, the amount of the salt of the metal ion to be dissolved in the solvent falls in the range with start and end points selected from the following group of numbers: 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, and 20 wt. % of the solution. In various embodiments, the metal ion is silver ion and the ligand is a nitrile group; and wherein the silver ions are linked to the nitrile ligands via coordination bonds to form a [Ag(N≡C—)ₓ]⁺ complex, wherein x is an integer that is no less than 1 and no more than 3.

In various embodiments, the solvent for forming the metal ion coordination polymer is compatible with the ligand and metal ion used, such that coordination bonds can be formed effectively. In various embodiments, the solvent is an organic solvent. In various embodiments, the solvent is a polar solvent. In various embodiments, the solvent is a reducing solvent, e.g., dimethylformamide (DMF). In various embodiments, a reducing solvent is a type of solvent that has the ability to donate electrons to other chemical species, thereby reducing them. In various embodiments, the reducing solvent may reduce the metal ions, e.g., silver ions, in the metal ion coordination polymer to metal nanoparticles, e.g., silver nanoparticles. In various embodiments, the reduction of metal ions to metal nanoparticles may advantageously stabilize the network structure of the metal ion coordination polymer. In various embodiments, the reduction of metal ions to metal nanoparticles may advantageously make the fiber electrically conductive. In various embodiments, the solvent is a non-reducing solvent, e.g., N-methyl-2-pyrrolidone (NMP). In various embodiments, the solvent includes but is not limited to DMF, NMP, a mixture of DMF-water, and a mixture of NMP-water.

In various embodiments, preparing the dope further comprises curing the solution of the polymer resin and the metal ion source to obtain the dope comprising the metal ion coordination polymer. In various embodiments, the solution of the polymer resin and the metal ion source may be subjected to thermal curing. In various embodiments, the thermal curing temperature may fall in the range of from about 20° C. to about 90° C. In various embodiments, the solution of the polymer resin and the metal ion source may be cured at room temperature, e.g., at constant room temperature. In various embodiments, the room temperature may fall in the range of from about 20° C. to about 30° C. In various embodiments, the curing temperature may fall in the range with start and end points selected from the following group of numbers: 20, 25, 30, 35, 40, 45, 50, 55, 60, 65, 70, 75, 80, 85, and 90° C.

In various embodiments, the solution of the polymer resin and the metal ion source is cured for a duration falling in the range of from 5 hours to 150 hours at a temperature falling in the range of from 20° C. to 90° C. In various embodiments, the solution of the polymer resin and the metal ion source is cured for a duration falling in the range with start and end points selected from the following group of numbers: 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, 100, 105, 110, 115, 120, 125, 130, 135, 140, 145, and 150 hours.

In various embodiments, the solution of the polymer resin and the metal ion source is cured until the dope has a viscosity falling in the range of from 10 Pa·s to 100 Pa·s. In various embodiments, the solution of the polymer resin and the metal ion source is cured until the dope has a viscosity falling in the range with start and end points selected from the following group of numbers: 10, 15, 20, 25, 30, 35, 40, 45, 50, 55, 60, 65, 70, 75, 80, 85, 90, 95, and 100 Pa·s. In various embodiments, the solution of the polymer resin and the metal ion source is cured until the dope has a storage modulus falling in the range of from 100 Pa to 500 Pa. In various embodiments, the solution of the polymer resin and the metal ion source is cured until the dope has a storage modulus falling in the range with start and end points selected from the following group of numbers: 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500 Pa. In various embodiments, the solution of the polymer resin and the metal ion source is cured until the dope has a loss modulus falling in the range of from 1 Pa to 200 Pa. In various embodiments, the solution of the polymer resin and the metal ion source is cured until the dope has a loss modulus falling in the range with start and end points selected from the following group of numbers: 1, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, and 200 Pa. In various embodiments, the solution of the polymer resin and the metal ion source is cured until the dope satisfies one or more of the following conditions: (i) a viscosity falling in the range of from 10 Pa·s to 50 Pa·s; (ii) a storage modulus falling in the range of from 100 Pa to 200 Pa; and (iii) a loss modulus falling in the range of from 10 Pa to 150 Pa.

In various embodiments, the spinnability of a dope (e.g., a polyacrylonitrile-silver ion (PANSion) spinning solution) may be controlled by a combination of factors. These factors include, for example, curing time, curing temperature, concentration of polymer resin (e.g., polyacrylonitrile (PAN) concentration), concentration of metal ions (e.g., silver ions), storage conditions, and shelf life, etc. In various embodiments therefore, a dope with a suitable spinnability may be obtained by controlling the combination of factors. In various embodiments, one of the factors may be varied while keeping the other factors fixed.

In various embodiments, the curing time may be varied to control the spinnability while the curing temperature, metal ion concentration, and polymer concentration are fixed. In various embodiments, extending the curing time may continuously increase the viscosity of a dope regardless of the curing temperature or metal ion concentration. It will be appreciated that insufficient curing or over-curing of the dope would result in no spinnability because the solution is either too thin in the case of insufficient curing, or gelation occurs in the case of over-curing.

In various embodiments, the curing temperature may be varied to control the viscosity of a dope. For example, the curing temperature may be raised so that a higher crosslinking rate via metal ion coordination complexes (e.g., [Ag(N≡C—)ₓ]⁺) is achieved. That is, a higher viscosity of the dope may be achieved in a shorter time at a higher temperature.

In various embodiments, the polymer concentration may be varied to control the viscosity of a dope. For example, in some embodiments, a polymer solution having 2 wt. % of polymer resin (e.g., polyacrylonitrile) may be too thin to obtain a spinnable dope because of insufficient inter- or intrachain interactions. For example, in some embodiments, a polymer solution having more than 15 wt. % of polymer resin may be too thick for spinning fibers.

In various embodiments, the metal ion concentration may be varied to control the viscosity of a dope. For example, in some embodiments, a higher metal ion (e.g., Ag⁺) concentration may increase the viscosity of a dope as a higher concentration of metal ions may result in a higher density of the metal ion coordination complexes (e.g., [Ag(N≡C—)ₓ]⁺) acting as crosslinker.

In various embodiments, the storage conditions and shelf life (i.e., time window/interval from the generation of a spinnable dope to the use of the dope for spinning) may be relevant for industrial production. For example, in some embodiments, a spinnable dope may be obtained via room temperature curing for about 72 hours and maintains good spinnability even after about 24 hours of room temperature storage. Although high-temperature curing (e.g., 50-60° C.) may shorten the preparation time of a dope or spinning solution, it may also limit the time window for smooth spinning under ambient conditions. In various embodiments therefore, while room-temperature curing may require a longer time to reach the optimal spinnability, it may advantageously allow a wider time window to work with the dope.

In various embodiments, forming the precursor fiber comprises spinning the precursor from the dope. In various embodiments, forming the precursor fiber comprises extruding the dope from an opening, e.g., hole(s) or nozzle of a fiber forming apparatus, e.g., an extrusion apparatus or spinning apparatus, in air while continuously stretching and collecting the fiber on a collector module. In various embodiments, forming the precursor fiber may further comprise drawing or stretching the precursor fiber from the dope in air to a desired length and/or diameter. In various embodiments, forming the precursor fiber may comprise drawing a thread out of a gel dope. In various embodiments, forming the precursor fiber may comprise stretching a ball of dope into a thin thread, e.g., between two tweezers, until a specific diameter and/or length of the fiber is achieved. In various embodiments, the diameter of a fiber may be controlled by controlling a stretching ratio, e.g., when manually spinning fiber. In various embodiments, the stretching ratio is typically expressed as a dimensionless ratio or a percentage increase in length calculated by dividing the final length of the material by its initial length.

In various embodiments, the precursor fiber is formed from the dope under ambient conditions. In various embodiments, the precursor fiber is formed from the dope in air having atmospheric pressure. In various embodiments, the precursor fiber is formed from the dope in air having a relative humidity falling in the range of from 40% to 95%. In various embodiments, the precursor fiber is formed from the dope in air having a temperature falling in the range of from 20° C. to 50° C. In various embodiments, the relative humidity of the air may fall in the range with start and end points selected from the following group of numbers: 40, 45, 50, 55, 60, 65, 70, 75, 80, 85, 90, and 95%. In various embodiments, the air temperature may fall in the range with start and end points selected from the following group of numbers: 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, and 50° C. In various embodiments, the formation of the precursor fiber from the dope is devoid of applying external heat that is outside of ambient temperature.

In various embodiments, the method may facilitate formation of a multifunctional fiber via a single step process, i.e., a single step spinning process by forming fibers from a spinnable dope in air. In various embodiments, the method of forming a fiber is devoid of post spinning treatment steps. In various embodiments, post spinning treatment steps may include but are not limited to thermal heating, in-line UV curing, coagulation bath, and exposure to hot steam.

In various embodiments, there is provided a fiber comprising a metal ion coordination polymer, said metal ion coordination polymer comprising a plurality of metal ions acting as nodes; and a plurality of organic ligands acting as linkers, wherein the metal ions are linked to the organic ligands via coordination bonds to form a network structure of the metal ion coordination polymer. In various embodiments, the fiber comprises an in-situ-grown metal ion-polymer framework. In various embodiments, the fiber further comprises nanoparticles of the metal interspersed in the network structure of the metal ion coordination polymer. In various embodiments, the metal ion is silver ion and the ligand is a nitrile group; and wherein the silver ions are linked to the nitrile ligands via coordination bonds to form a [Ag(N≡C—)ₓ]⁺ complex, wherein x is an integer that is no less than 1 and no more than 3.

In various embodiments, the fiber may have a substantially smooth exterior surface. In various embodiments, the fiber may have a substantially uniform diameter. In various embodiments, the fiber may have an average diameter falling in the range of from about 1 μm to about 1000 μm. In various embodiments, the fiber may have an average diameter falling in the range with start and end points selected from the following group of numbers: 1, 2, 3, 4, 5, 6, 7, 8, 9, 10, 15, 20, 25, 30, 35, 40, 45, 50, 55, 60, 65, 70, 75, 80, 85, 90, 95, 100, 150, 200, 250, 300, 350, 400, 450, 500, 550, 600, 650, 700, 750, 800, 850, 900, 950, and 1000 μm. In various embodiments, the fiber may have a circular or elliptical shaped cross section. In various embodiments, the fiber may have a solid internal structure. In various embodiments, the fiber may have submicrometer internal pores. In various embodiments, the fiber may be substantially devoid of large internal pores, e.g., pores that are larger than 1 micrometer. In various embodiments, fiber may have a length that is dependent on the gel fiber forming equipment, e.g., spinning equipment that is used for industrial production.

In various embodiments, the fiber is stretchable. In various embodiments, the stretchability of the fiber may be defined by its failure strain (also known as strain-to-failure or elongation at break). Failure strain is a material property that measures the amount of deformation a material can undergo before it fractures or breaks. It quantifies the extent to which a material can be stretched or deformed without losing its structural integrity. In various embodiments, the stretchability of the fiber is substantially unaffected by temperature quenching. In various embodiments, the fiber may exhibit strain-hardening, which is a mechanical phenomenon in which a material becomes stronger and more resistant to deformation as it is plastically deformed. In various embodiments, the fiber may exhibit a strain rate-dependent property, which is a material characteristic that changes in response to variations in the rate at which deformation (strain) is applied to the material. In other words, the mechanical behavior or performance of the material is influenced by the speed at which it is subjected to a load or deformation. In various embodiments, the fiber may exhibit a strain rate-dependent property when the strain rate is in the range of from about 1 mm/min to about 1000 mm/min.

In various embodiments, the fiber may have a failure strain falling in the range of from about 100% to about 600%. In various embodiments, the fiber may have a failure strain falling in the range with the following start and end points: 100, 150, 200, 250, 300, 350, 400, 450, 500, 550, and 600%. In various embodiments, the fiber may have a failure strain of at least about 100%, at least about 150%, at least about 200%, at least about 250%, at least about 300%, at least about 350%, at least about 400%, at least about 450%, at least about 500%, or at least about 550%.

In various embodiments, the fiber may be electrically conductive. In various embodiments, the fiber may have an electrical conductivity of from about 0.1 S/m to about 100 S/m. In various embodiments, the fiber may have an electrical conductivity falling in the range with start and end points selected from the following group of numbers: 0.1, 0.2, 0.3, 0.4, 0.5, 0.6, 0.7, 0.8, 0.9, 1, 2, 3, 4, 5, 6, 7, 8, 9, 10, 15, 20, 25, 30, 35, 40, 45, 50, 55, 60, 65, 70, 75, 80, 85, 90, 95, and 100 S/m. In various embodiments, the electrical conductivity of the fiber may change in response to deformation of the fiber.

In various embodiments, the fiber may have a tensile strength of from about 0.5 MPa to about 8 MPa. In various embodiments, the fiber may have a tensile strength of at least about 0.5 MPa, at least about 2 MPa, at least about 4 MPa, or at least about 6 MPa. In various embodiments, the tensile strength of the fiber may fall in the range with start and end points selected from the following group of numbers: 0.5, 1, 1.5, 2, 2.5, 3, 3.5, 4, 4.5, 5, 5.5, 6, 6.5, 7, 7.5, and 8 MPa. In various embodiments, the tensile strength of the fiber is tunable. In various embodiments, the tensile strength may be tuned according to the strength requirements of specific applications.

In various embodiments, the fiber is recyclable. In various embodiments, the fiber is redissolvable in an organic solvent, e.g., DMF. In various embodiments, the fiber is water stable. In various embodiments, the fiber is insoluble in water. The recyclability of the fiber may advantageously avoid waste of soft electronics.

In various embodiments, the fiber may be thermally sensitive. In various embodiments, the fiber may be used as thermal sensors in thermal sensing applications. In various embodiments, the fiber may be capable of detecting changes in temperature of a surface. In various embodiments, the fiber may exhibit changes in electrical and/or mechanical properties in response to variations in temperature. For example, the fiber may exhibit a change in electrical resistance or conductivity in response to a change in temperature.

In various embodiments, the fiber(s) may be used on its own as a self-sensing strainer, with or without any post treatment step. In various embodiments, the fiber may be incorporated into textile, e.g., sewn in commercial textile. In various embodiments, the incorporation of one or more fibers into a textile may advantageously convert an ordinary textile into a smart textile with functions such as sensing functions. In various embodiments, the smart textile may be used in various applications such as energy, sensing and therapeutic applications. In various embodiments, the fiber may be used in applications including but not limited to healthcare, sports, and human-machine interfaces.

In various embodiments, there is provided an article comprising one or more strands of fibers formed by the presently disclosed method, or one or more strands of fibers as disclosed herein.

In various embodiments, the article may be a textile. In various embodiments, the article may be a smart textile with multimodal sensing abilities. In various embodiments, the textile may be a commercial textile with one of more fibers integrated therein. In various embodiments, the article may be a glove formed from a smart textile. In various embodiments, the glove may have sensing capabilities, e.g., sensing glove capable of providing feedback in response to mechanical, thermal, and/or electrical cues. In various embodiments, the glove may be used in human-machine interface applications. In various embodiments, the article may be a face mask formed from a smart textile, i.e., smart face mask.

In various embodiments, there is provided a bioinspired, biomimetic, low-energy phase separation-enabled ambient (PSEA) spinning approach to fabricate functional fibers by mimicking silk spinning by spiders. In various embodiments, the method provides a simple yet efficient spinning approach under ambient conditions (e.g., 75% relative humidity (RH) at 24° C.) to produce functional soft fibers as elegant as silk spinning by spiders. In various embodiments, the method enables fabrication of functional soft fibers under benign conditions with minimum energy consumption compared with typical thermal drawing or other extrusion processes. In various embodiments, the PSEA spinning is facilitated by silver-coordinated elastic supramolecular networks and in situ formed silver nanoparticles. In various embodiments, functional fibers, e.g., soft fibers, produced by the spinning approach are mechanically stretchable (>500% strain), strong (>6 MPa), and electrically conductive (˜1.82 S/m). In various embodiments, the biomimetic PSEA spinning technique provides a sustainable approach to creating functional fibers. In various embodiments, the functional fibers may be widely adopted for constructing smart textiles with multimodal sensing abilities. In various embodiments, the functional fibers may be used in a myriad of applications, such as wearable electronics, including haptic sensing, tactile sensing, human-machine interfaces, personalized healthcare products, breath monitoring, cryptographic communication and 2D pattern construction.

### BRIEF DESCRIPTION OF FIGURES

FIG. 1 is a schematic flowchart for illustrating a method of forming a fiber in an example embodiment.

FIG. 2A is a schematic diagram for illustrating a method of spinning natural silk by spiders.

FIG. 2B is a schematic diagram for illustrating a method of spinning a fiber in an example embodiment.

FIG. 2C is a schematic diagram for illustrating a fiber formation mechanism in the example embodiment.

FIG. 2D is a series of radar charts comparing the fibers formed by the presently disclosed method and other typical polymer elastomers in terms of energy costs from melting, intrinsic stretchability, and intrinsic conductivity in an example embodiment.

FIG. 3A is a schematic diagram for illustrating an atomic force microscopy-based single-molecule force spectroscopy (AFM-SMFS) characterization setup in an example embodiment.

FIG. 3B is a force-extension spectra of PAN and PANSion dopes in an example embodiment. Worm-like chain fits of the spectra are shown for PANSion dopes #1 to #3. Results for the PAN dope show no detectable force rupture peaks and results for the PANSion dopes show force rupture peaks at different contour lengths.

FIG. 3C is a histogram of contour length L_{C} with three representative values, estimated to be 106+33, 332+82 and 389+23 nm (values are reported as mean±standard deviation) in the example embodiment.

FIG. 3D is a box plot (center line at the median, upper bound at the 75^{th} percentile, lower bound at the 25^{th} percentile and whiskers at the minimum and maximum values with outliers are not counted; each dot represents one test) of rupture forces at the three corresponding values of L_{C} in the example embodiment. The rupture forces are estimated to be 134±76, 127±105 and 280±170 pN (values are reported as mean±standard deviation, n=500 independent tests for L_{C}=106 nm, n=170 for L_{C}=332 nm and n=389 for L_{C}=106 nm).

FIG. 3E is plot showing two cycles of force-extension spectra (stretching-releasing and stretching to break), indicating the elasticity of PANSion supramolecular networks in the example embodiment.

FIG. 4A is a series of photographs comparing spinnability between polyacrylonitrile (PAN) and polyacrylonitrile-silver ion (PANSion) dopes after 0 to 24 hours of curing at 24° C. in an example embodiment. Both dopes cannot generate self-supporting fibers under ambient conditions.

FIG. 4B is a series of photographs comparing spinnability between polyacrylonitrile (PAN) and polyacrylonitrile-silver ion (PANSion) dopes after 36 to 72 hours of curing at 24° C. in an example embodiment.

FIG. 4C is a photograph showing a PANSion fiber formed between two legs of a tweezer using PANSion dope after 72 hours of curing in an example embodiment.

FIG. 4D is a pair of optical microscope (OM) images of PANSion fibers with liquid droplets hanging on them in an example embodiment.

FIG. 4E is a graph showing viscosity changes of PANSion dope after curing for various times in an example embodiment. A significant viscosity increase was recorded after 60 hours of curing for PANSion dope, indicating strong inter- or intra-chain interactions via [Ag(N≡C—)ₓ]⁺ complexes. Viscosity data were obtained by extrapolating the fitting curves when shear rate \dot{γ}→0. The filled dot represents the result for the control sample of PAN.

FIG. 4F is a graph showing viscosity as a function of shear rate for PANSion dopes with different curing times in an example embodiment.

FIG. 4G is a graph showing oscillatory amplitude sweep results in the range of 0.1 to 2000% strain at 24° C. (frequency ω=1 rad/s) for samples after 0 to 40 hours of curing in an example embodiment.

FIG. 4H is a graph showing oscillatory amplitude sweep results in the range of 0.1 to 2000% strain at 24° C. (frequency ω=1 rad/s) for samples after 48 to 96 hours of curing in an example embodiment.

FIG. 4I is a graph showing oscillatory frequency sweep results in the range of 0.1 to 200 rad/s at 24° C. (amplitude strain=1%) for samples after 0 to 40 hours of curing in an example embodiment.

FIG. 4J is a graph is a graph showing oscillatory frequency sweep results in the range of 0.1 to 200 rad/s at 24° C. (amplitude strain=1%) for samples after 48 to 96 hours of curing in an example embodiment.

FIG. 4K is a graph showing results of a cyclic step-strain test in an example embodiment.

FIG. 5A is a photograph showing direct spinning of a polyacrylonitrile-silver ion (PANSion) fiber under ambient conditions (75% RH, about 24° C.) in an example embodiment.

FIG. 5B is a series of photographs showing manual spinning of a PANSion fiber via a PSEA spinning method using two tweezers in air in an example embodiment.

FIG. 5C is a group of photographs comparing ambient condition spinnability of polyacrylonitrile (PAN) and PANSion dopes held between two metal plates in an example embodiment. The inset in the third photograph shows solvent droplets on a solid PANSion fiber upon phase separation.

FIG. 5D is a series of time-sequence photographs of a PANSion gel fiber held between two metal plates under ambient conditions (75% RH, about 24° C.) in an example embodiment.

FIG. 5E is a schematic diagram for illustrating a setup for implementing a wet spinning process in an example embodiment.

FIG. 5F is a pair of photographs showing wet spinning of PAN and PANSion fibers in an example embodiment.

FIG. 6A is a series of optical microscope images showing fiber formation in an example embodiment. The white arrows mark precipitated solvent droplets on a solid PANSion fiber. Scale bar=50 μm.

FIG. 6B is a series of photographs showing a PANSion gel ball rapidly coalesced with a water droplet, resulting in phase separation along with solid-phase contraction and solidification in an example embodiment. Scale bar=5 mm.

FIG. 6C is an OM image showing a solid PANSion fiber with liquid droplets disposed thereon in an example embodiment. Scale bar=500 μm.

FIG. 6D is an OM image showing two neighboring liquid droplets on a solid PANSion fiber in an example embodiment. Scale bar=100 μm.

FIG. 6E is a graph showing a profile of fiber diameter changes (normalized to the initial diameter value) as a function of time when undergoing phase separation in an example embodiment.

FIG. 6F is a photograph of a meters-long fiber on a wooden bobbin in an example embodiment, Scale bar=0.5 cm.

FIG. 6G is a schematic diagram for illustrating a phase evolution of a precursor gel fiber under ambient conditions from a longitudinal section of the fiber in an example embodiment. The different phases of evolution are continuous water-vapour adsorption; phase separation due to non-solvent (water) accumulation; and a solid gel fiber with solvent droplets hanging on it.

FIG. 7A is a graph showing a diameter change profile of a simulated fiber compared with experimental and theoretical data in an example embodiment.

FIG. 7B is a series of snapshots of coarse-grain molecular dynamics (CG-MD) of a phase separation process at four representative time points: 10, 50, 100 and 300 ns in an example embodiment.

FIG. 7C is an image showing an initial cross-section of a simulated precursor gel fiber in a humidity-controlled environment (75% RH) in an example embodiment.

FIG. 7D is an image showing spatial and temporal distributions of mass density of a DMF solvent from the line a-a′ in FIG. 7C, showing outward diffusion of the DMF solvent with dynamic mass transfer.

FIG. 7E is an image showing spatial and temporal distributions of mass density of a PANSion solute from the line a-a′ in FIG. 7C, showing contraction and solidification of the PANSion solute with dynamic mass transfer.

FIG. 8A is a pair of scanning electron microscope (SEM) images showing a surface morphology and a cross-sectional morphology of a PANSion fiber in an example embodiment. Scale bar of top image=200 μm. Scale bar of bottom image=50 μm. The inset in the top image shows an enlarged fiber surface (scale bar=50 μm).

FIG. 8B is a group of energy dispersive X-ray (EDX) mappings showing elemental compositions from the dashed-box area in FIG. 8A in an example embodiment. Scale bar=10 μm.

FIG. 8C is a group of photographs showing the ability of PANSion fibers to re-dissolve in DMF solvent in an example embodiment. Scale bar=1 cm.

FIG. 8D is a group of photographs showing the flexibility of a PANSion fiber in an example embodiment. The top left photograph depicts a knot showing the flexibility of the PANSion fiber (scale bar=100 μm). The bottom left photograph depicts a PANSion fiber sewed into a cotton fabric (scale bar=600 μm). The right photograph depicts a PANSion fiber passing through the hole of a needle (scale bar=5 mm).

FIG. 8E is a graph showing stress-strain curves of PAN (stiff and brittle) and PANSion (soft and stretchable) fibers in an example embodiment.

FIG. 8F is a circuit diagram (top) showing a PANSion fiber being used as a conductor in a circuit with a light emitting diode (LED) and a series of photographs (bottom) showing how the intensity of the LED changes in response to stretching of the PANSion fiber in an example embodiment.

FIG. 8G is a graph showing resistance changes of a fiber conductor under axial stretching in an example embodiment.

FIG. 9A is a schematic diagram showing a configuration used to control on-off switching of an LEDs using a sensing glove in an example embodiment.

FIG. 9B is a pair of photographs showing LED intensity control by varying finger bending angles of a sensing glove in an example embodiment.

FIG. 9C is a series of photographs showing on-and-off combinations of three LEDs by wagging the index, middle, and ring fingers, respectively of a sensing glove in an example embodiment.

FIG. 9D is a schematic diagram showing the working principle of a sensing glove as a human-machine interface for a “rock-paper-scissors” hand game in an example embodiment.

FIG. 9E is a schematic diagram showing a scenario of a kid playing a “rock-paper-scissors” hand game by wearing the glove in an example embodiment.

FIG. 9F is a schematic diagram showing a sensing mask with a fiber in the middle filter layer in an example embodiment. Scale bar=5 mm.

FIG. 9G is a graph showing how the sensing mask of FIG. 9F is used for monitoring breathing status by distinguishing inhalation-exhalation behaviors under normal breathing condition in the example embodiment.

FIG. 9H is a graph showing how the sensing mask of FIG. 9F is used for monitoring breathing status by distinguishing inhalation-exhalation behaviors under post exercise breathing condition in the example embodiment.

FIG. 91 is a graph showing how the sensing mask of FIG. 9F is used for monitoring breathing status by distinguishing inhalation-exhalation behaviors under abnormal breathing condition in the example embodiment.

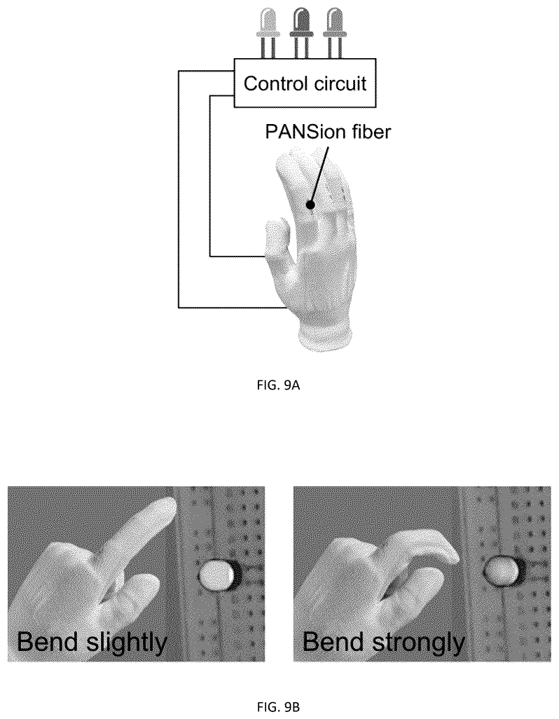

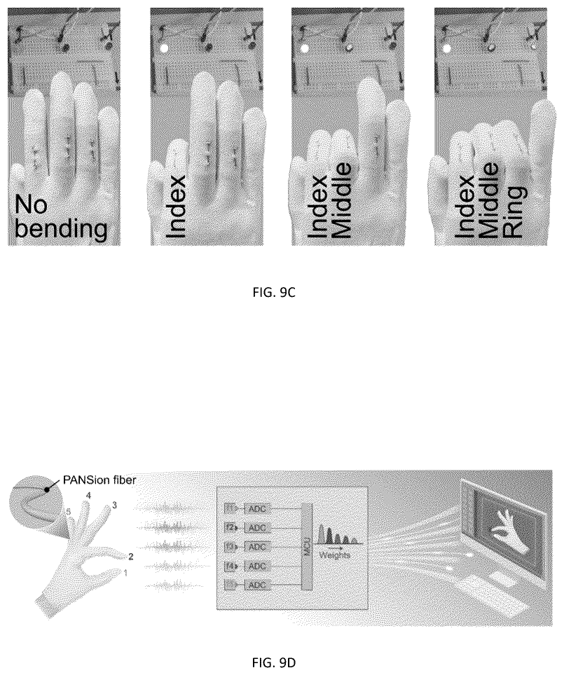

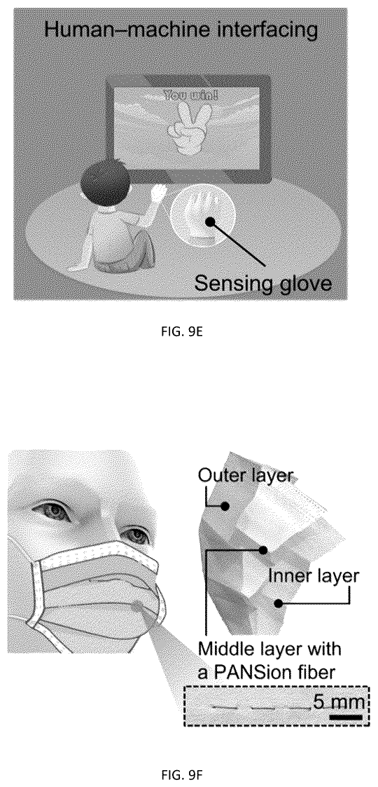

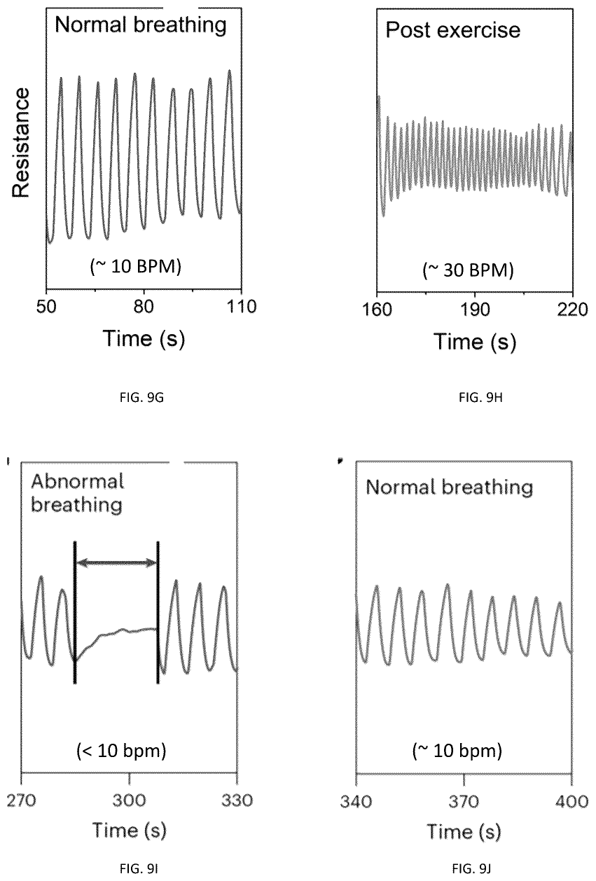

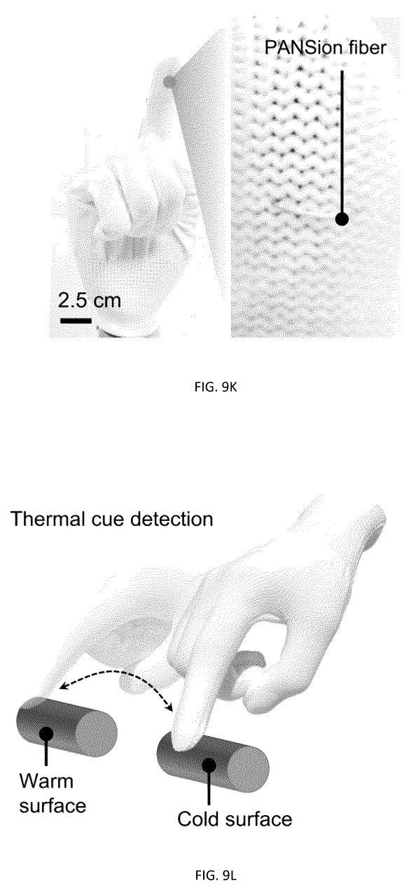

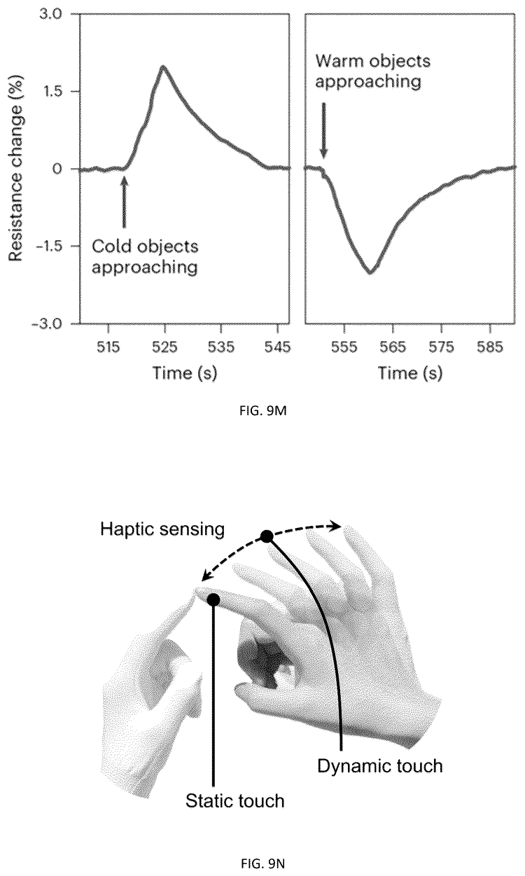

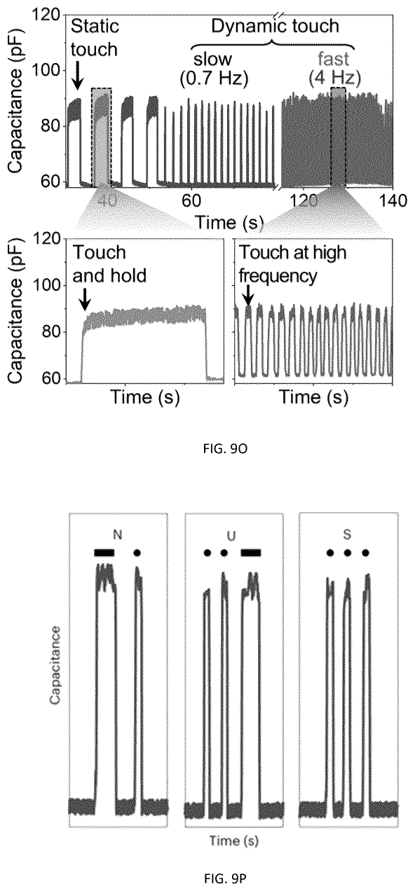

FIG. 9J is a graph showing how the sensing mask of FIG. 9F is used for monitoring breathing status by distinguishing inhalation-exhalation behaviors under normal breathing condition in the example embodiment.

FIG. 9K is a photograph showing a sensing glove with a fiber at the fingertip area in an example embodiment. Scale bar=2.5 cm.

FIG. 9L is a schematic diagram showing the ability of a sensing glove to sense a thermal cue in an example embodiment.

FIG. 9M is a graph showing sensing signals from the sensing glove when approaching cold and warm objects in the example embodiment.

FIG. 9N is a schematic diagram showing haptic sensing of a sensing glove with regard to finger touches in an example embodiment.

FIG. 90 is a graph showing sensing signals from a sensing glove, generated by various touch patterns, including static (touch and hold) and dynamic (slow/fast frequency) touches in an example embodiment.

FIG. 9P is a graph showing encoded touch patterns as a form of Morse code for human-machine interface applications in an example embodiment.

### DETAILED DESCRIPTION OF FIGURES

Example embodiments of the disclosure will be better understood and readily apparent to one of ordinary skill in the art from the following discussions and if applicable, in conjunction with the figures. It should be appreciated that other modifications related to structural, material, electrical and chemical changes may be made without deviating from the scope of the invention. Example embodiments are not necessarily mutually exclusive as some may be combined with one or more embodiments to form new exemplary embodiments. The example embodiments should not be construed as limiting the scope of the disclosure.

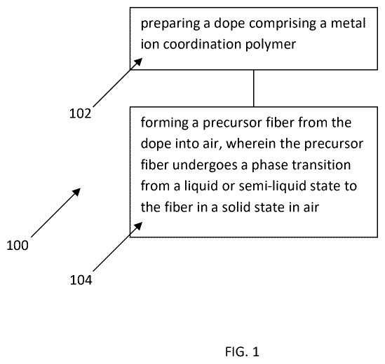

FIG. 1 is a schematic flowchart 100 for illustrating a method of forming a fiber in an example embodiment. At step 102, a dope comprising a metal ion coordination polymer is prepared. At step 104, a precursor fiber is formed from the dope in air, wherein the precursor fiber undergoes a phase transition from a liquid or semi-liquid state to the fiber in a solid state in air.

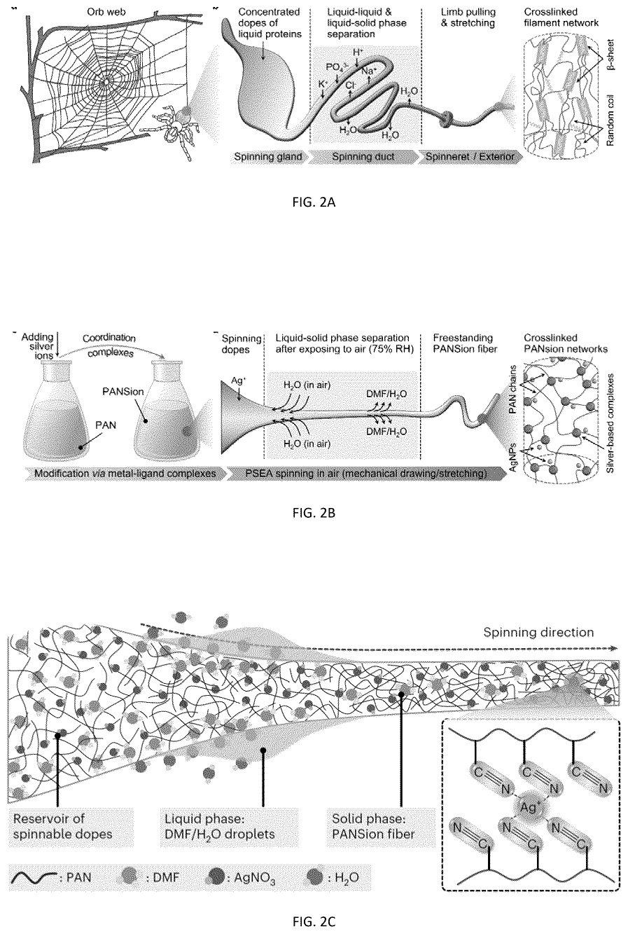

FIG. 2A is a schematic diagram for illustrating a method of spinning natural silk by spiders. In nature, spider silk is used to build an orb web. Spiders have specialized spinning glands located in their abdomen for producing silk proteins. The method of spinning natural silk begins with the spider extruding liquid silk proteins from the specialized spinning glands. The silk proteins are dissolved in a watery solution to form a semi-liquid substance (see concentrated dopes of liquid proteins in FIG. 2A). The liquid proteins pass through a series of spinning ducts within the spider's abdomen. Along these spinning ducts, there are small structures called spigots that help control the thickness and properties of the silk being produced. Liquid-liquid and liquid-solid phase separation occur as the liquid proteins pass through the spinning ducts. Sequential changes to protein conformation that assist the liquid-to-solid phase transition are important in enabling the fabrication of multifunctional silk. The sequential changes to protein conformation are induced by external stimuli, including acidification, ion flux, and dehydration. The spider manipulates the silk with its spinnerets, which are specialized appendages located at the rear end of its abdomen. The spinnerets can move and manipulate the silk as it emerges, allowing the spider to create various silk structures. The spider uses its limbs manipulate the silk by pulling and stretching, weaving it into the desired shape. The resultant silk fiber comprises a crosslinked filament network made up of random coils and β-sheet structures.

FIG. 2B is a schematic diagram for illustrating a method of spinning a fiber in an example embodiment. FIG. 2C is a schematic diagram for illustrating a fiber formation mechanism in the example embodiment. Inspired by the supramolecular assembly and phase transition of spider silk proteins, the presently disclosed method provides a bioinspired, low-energy consumption phase separation-enabled ambient (PSEA) spinning approach for preparing, e.g., spinning, functional soft fibers under natural conditions of room temperature and atmospheric pressure. Schematics of spinning dope preparation and fiber spinning are presented in FIG. 2B. First, a polymer resin, e.g., polyacrylonitrile (PAN; 10 wt. %) and a metal ion source, e.g., silver nitrate (which provided silver ions (Ag⁺)) are thoroughly dissolved in a solvent, e.g., dimethylformamide (DMF) to form coordination complexes. The mixed solution of PAN and silver ions (hereafter referred to as PANSion) is then cured for a specific time at a specific temperature, e.g., 24° C. to obtain a spinnable dope, e.g., spinnable gel dope. The formation of silver-based coordination complexes increases the strength of the supramolecular network for fiber spinning (see inset in FIG. 2C).

Subsequently, a PANSion fiber is spontaneously formed by drawing a precursor fiber, e.g., precursor gel fiber from the dope reservoir in air (75% relative humidity (RH) at 24° C.). Water-triggered non-solvent vapour-induced phase separation (NVIPS) transforms the dope into solid free-standing fibers when the dope is exposed to air. The in-situ reduction of silver ions into silver nanoparticles (AgNPs) also makes the fibers electrically conductive. The presently disclosed PSEA spinning technique eliminates the additional requirements of high pressure, thermal heating, or a coagulation bath, which are typically prerequisites of other spinning methods. Instant fiber formation is attributable to good spinnability of the dope under ambient conditions and nonsolvent vapor-induced phase separation (NVIPS) effect.

FIG. 2D is a series of radar charts comparing the fibers formed by the presently disclosed method and other typical polymer elastomers in terms of energy costs from melting, intrinsic stretchability, and intrinsic conductivity in an example embodiment. PANSion represents fibers produced by the presently disclosed method. PU represents polyurethane. PDMS represents polydimethylsiloxane. SEBS represents styrene-ethylene-butylene-styrene. PVA represents polyvinyl alcohol.

As shown in the first radar chart, the energy cost from melting is the lowest for PANSion fibers. Since no melting process is involved in the presently disclosed method, there is substantially no energy consumption (theoretically) during the spinning process via manual stretching (human labour is not considered for simplification). It is noted that energy input is needed when preparing the PANSion spinning solution from the magnetic stirring. Heating is not needed as PAN and silver nitrate (AgNO3) are substantially soluble in DMF. For most other fiber spinning methods, a relatively large quantity of energy is still required during the spinning process. For instance, for the thermal drawing method, melting is usually required to draw a fiber, which is an energy-intensive process (see Table 1). For wet spinning, the coagulation bath is required to be maintained at a specific temperature to sufficiently solidify the precursor fibers. Another disadvantage of wet spinning is the need for a coagulation bath which usually consumes a large quantity of water, salt solutions, or a mixture of water and organic solvents. On the other hand, a relatively small volume of DMF is needed when preparing the PANSion spinning solution.

As shown in the second and third radar charts, the intrinsic stretchability of PANSion is comparable to PU and SEBS, and the intrinsic conductivity is the highest for PANSion. It should be noted that PAN fiber or PAN film itself is neither stretchable (failure strain<1% via wet spinning approach) nor electrically conductive. To obtain a highly stretchable fiber, PAN polymer and silver ions are used to synthesize PANSion fiber. PANSion fiber is highly stretchable. At the same time, no additional processing from the synthesis process was required to achieve electrical conductivity. Therefore, stretchability and conductivity may be considered as intrinsic properties to PANSion as they were obtained from a single step synthesis process with no additional treatments. In contrast, the typical elastic polymers as shown in FIG. 2D (including SEBS, PDMS, PU, etc) are usually pure polymer systems. The syntheses of these elastomers are even more complicated than that of PANSion. More importantly, only mechanical softness and stretchability can be achieved with a relatively low electrical conductivity for those elastomers (see Table 1). For instance, while synthesizing PDMS from monomers of dimethyldichlorosilane, only mechanical stretchability can be obtained but not electrical conductivity.

TABLE 1
Comparison between PANSion fiber and other elastic fibers in terms
of intrinsic stretchability, conductivity and energy efficiency

| | Melting | | | | Heat | |
|---|---|---|---|---|---|---|
| | Temp | Stretchability | Conductivity | Density | Capacity | W_{melting} |
| | (° C.) | (%) | (S/m) | (g/cm³) | (J/g/° C.) | (J/cm³) |
| SEBS | 350 | 700 | 10⁻¹⁴³⁴ | 0.91 | 1.25 | 398.125 |
| PDMS | 53 | 160 | 10⁻¹⁴³⁶ | 0.97 | 1.625 | 83.54125 |
| PU | 171 | 800 | 10⁻¹⁶³⁸ | 1.2 | 0.665 | 136.458 |
| PVA | 233 | 0.46 | 10⁻¹⁰⁴⁰ | 1.3 | 1.5 | 454.35 |
| PAN | 322 | 1 | 10⁻¹⁰⁴¹ | 1.184 | 64 | 24399.87 |
| PANSion | — | >500 | 1.82 | — | — | ≈0 |

From FIG. 2D and Table 1, the stretchability of PANSion fibers is shown to be comparable to most elastic polymer fibers. Another advantage of PANSion fibers is that the intrinsic conductivity does not require additional processing from the synthesis process of the presently disclosed method, as compared to multi-step post treatments for other techniques known in the art. In other words, PANSion is similar to a conducting polymer in terms of conductivity but with a high stretchability.

Overall, the presently disclosed ambient condition spinning approach to produce functional soft fibers under ambient conditions with unified mechanical and electrical properties may advantageously be applied in a myriad of fields, such as green fabrication, sustainable fiber electronics, smart textiles electronics, artificial spinning techniques, percolated conductive polymer, and coordination complex chemistry, etc.

### EXAMPLES

### Materials

Polyacrylonitrile (PAN, average Mw, 150,000), N,N-dimethylformamide (DMF; anhydrous, 99.8%) and silver nitrate were purchased from Sigma-Aldrich. Deionized water (resistivity, >18 MΩ cm⁻¹) was collected from a water purification system from Millipore (Direct Q3). All the chemicals were used without further purification.

### Preparation of a Spinnable Dope

A PANSion solution was obtained by adding silver nitrate to a PAN solution (10 wt. % in DMF).

Briefly, 5.244 g of PAN powder was slowly added to the DMF solvent (50 ml) in a sealed glass reagent bottle and continuously stirred at 24° C. and 500 rpm using a magnet. Stirring was maintained overnight to obtain a well-dissolved homogeneous PAN solution. The weight ratio of the silver nitrate to PAN powder was fixed at 2:1 (1.177 M silver ions (Ag⁺)) to obtain an as-prepared PANSion solution. The as-prepared PANSion solution was then cured at 24° C. for a specific time. This resulted in the growth of a silver-coordinated supramolecular network, which in turn resulted in a PANSion gel dope with high spinnability.

To achieve good ambient conditions spinnability, the viscosity of the dope was purposely adjusted. It was found that the concentration of PAN solutions and the addition of AgNO3 affected the viscosity of the dope.

First, for the base solution of PAN, a too-thin (<5 wt. %) or too-thick (>15 wt. %) solution was not capable of forming a stable thread during mechanical stretching because of capillary instability or cohesive failure. Although a 10 wt. % PAN solution was unstable to support continuous fiber drawing under ambient conditions, this concentration could be easily achieved at room temperature, which also possessed an appropriate viscosity. On the one hand, the medium concentration was high enough to achieve a viscous solution. On the other hand, it was also in an appropriate range of weight ratio between PAN and DMF. Thus, the PAN powder could be easily dissolved into DMF at room temperature by mechanical stirring. Thus, 10 wt. % PAN solution was selected as the base solution for subsequent characterization studies.

Second, it was observed that the weight ratio with a value of 2:1 between AgNO₃ and PAN (namely, 1.177 M Ag⁺in 10 wt % PAN solution) was appropriate to establish a strong and dynamic supramolecular network after a specific time of room-temperature curing. For the weight ratio of 2:1, the density of crosslinking via [Ag(N≡C—)ₓ]⁺ complexes was sufficient to produce a favorable entangled network structure.

Third, when extending the curing time at room temperature, it was observed that there was a continuous increase of viscosity, storage, and loss modulus via rheological measurements, which confirmed that the formation of [Ag(N≡C—)ₓ]⁺ complex was done at a slow reaction rate. In other words, during the room-temperature curing, the silver-coordinated supramolecular structure gradually grew, forming a strong and dynamic structure. Consequently, after an appropriate time of curing at room temperature, the PANSion gel dope became viscoelastic and highly drawable, achieving good spinnability.

Therefore, by varying the room-temperature curing time, the properties of PANSion solutions can be adjusted, such as the entanglement density of the supramolecular chain network via [Ag(N≡C—)ₓ]⁺ complexes. Once an appropriate viscosity is reached for the spinning dope, the continuous drawing of a precursor PANSion gel fiber can be realized under ambient conditions (75% RH, about 24° C.).

This approach is referred to as phase separation-enabled ambient (PSEA) spinning. It is to be noted that a too-high or too-low crosslinking density of the supramolecular network may lead to poor spinnability.

### Characterization of Mechanical Properties of the Dope

Nanowizard 4 atomic force microscopy (AFM, JPK Germany) was used to conduct single-molecule force spectroscopy (SMFS) experiments at room temperature. AFM cantilever (MLCT-Bio-DC, Bruker, United States) with a spring constant (k) of about 40 pN/nm was used. The equipartition theorem was used to calibrate the spring constant of each cantilever in a solution with an accurate value before the experiment. Typically, an 800 μL solution was added to a clean glass coverslip for AFM-SMFS measurement. First, the cantilever contacted the surface with an indentation force of about 1 nN for 1 second and randomly picked up a molecule. Then, the cantilever moved up vertically, in which the captured PAN or PANSion molecular chain was stretched. Finally, the chain broke upon further stretching, leading to a rupture force peak in the force-extension curve. Igor Pro 6.12 (WaveMetrics 486 Inc.) was used for AFM-SMFS data analysis, and the worm-like-chain (WLC) model was used to fit the data as an interpretation of polymer elasticity.

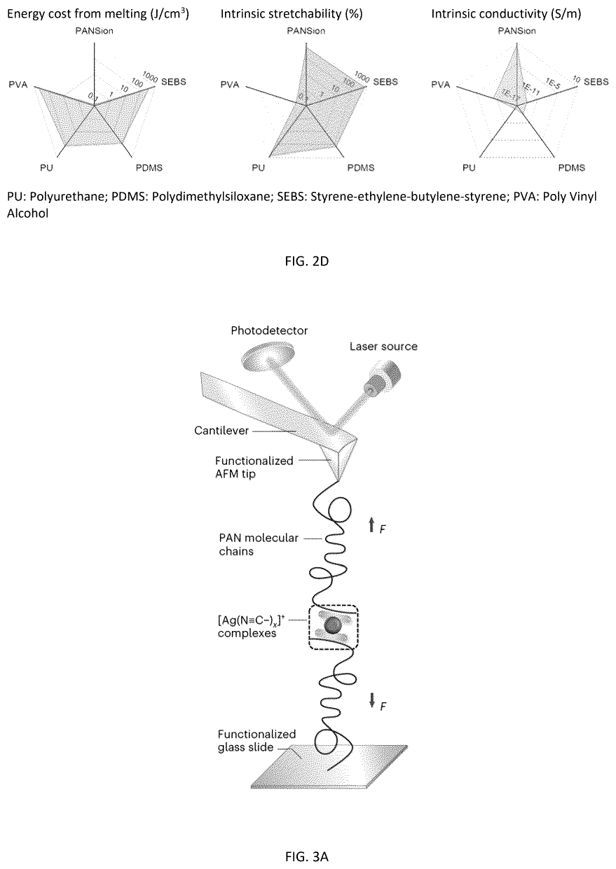

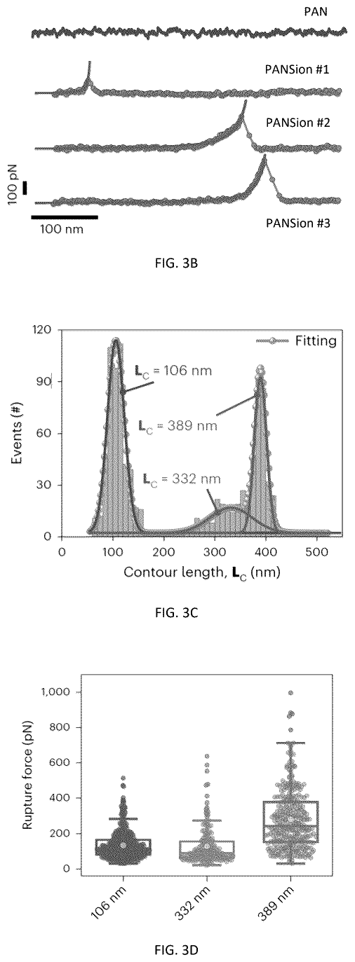

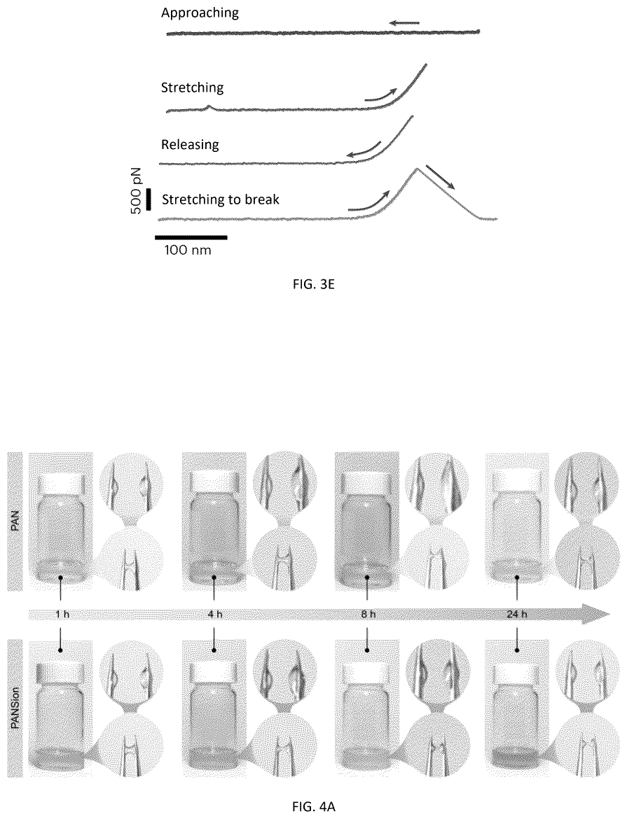

The presence of the coordination complexes in a dope was first verified via atomic force microscopy (AFM)-based single-molecule force spectroscopy (SMFS) (see FIG. 3A). In contrast to the random noise force signals from the control PAN dope (see FIG. 3B), peaks of force rupture were detected for the PANSion dopes due to the presence of [Ag(N≡C—)ₓ]⁺ complexes. There were three different contour lengths (L_{C}; the length before force rupture), statistically averaged at 106, 332 and 389 nm, respectively (see FIG. 3C). These are attributed to the random sites of silver coordination complex formation along the polymer chains.

The rupture force distribution of each representative L_{C} was further analyzed and averaged at about 130 pN for the shorter L_{C} values at 106 and 322 nm, and 280 pN for the longer L_{C} at 389 nm, respectively (see FIG. 3D). Such broad distributions of rupture force can be explained by the versatile molecular conformations of the [Ag(N≡C—)ₓ]⁺ complexes, which favor the formation of stable, strong and dynamic supramolecular structures, thereby assisting in the establishment of a good ambient-condition spinnability.

Additionally, owing to the dynamic and robust nature of the [Ag(N≡C—)ₓ]⁺ complexes, the cyclic force-extension curves obtained from the AFM-SMFS tests show that the PANSion network had a more elastic structure (see FIG. 3E) in which the polymer chains exhibited good elasticity and recyclability. These experimental findings corroborated with the simulation results at the molecular level.

### Characterization of Rheological Properties of the Dope

Rheological properties of spinning dopes were characterized using a Rheometer (Anton Paar, MCR 302) with a parallel plate of 025 mm in the shear rate range.

Viscosity characterization was conducted in the shear rate range from 0.1 to 1000 s-1, from which data were fitted using a Carreau-Yasuda model:

$$η = {η}_{0} \times {[ 1 + {( \dot{γ} τ )}^{a} ]}^{\frac{n - 1}{a}}$$

where τ is the relaxation time of viscoelastic fluids (τ=1/γ̅_{c}, \dot{γ}_{c} is the critical shear rate of the onset of shear-thinning). n is the characteristic power-law exponent at high shear rates, and the coefficient a describes the transformation between the zero-shear-rate region and the power-law region.

An oscillatory amplitude sweep was done at a constant angular frequency of 0.628 rad/s in the strain range of 0.1 to 2000%. An oscillatory frequency sweep was done at a controlled shear strain of 1% over the frequency range of 0.1 to 200 rad/s.

Step-strain characterization was done on a sample after 96 hours of curing by alternating strains between 5% and 1000%. The electrical conductivity (p) of PANSion fiber was calculated based on the following equation:

$$ρ = \frac{π {d}^{2} R}{4 L}$$

where L is the length, R is the electrical resistance, and d is the diameter of fibers.

All resistance and capacitance data were collected using a Keithley multimeter (Model 2450). The energy saving from polymer melting via a thermal drawing or extrusion process was calculated using the following equation:

$${W}_{melting} = {ρ}_{polymer} \cdot {C}_{p ( polymer )} \cdot {T}_{melting ( polymer )}$$

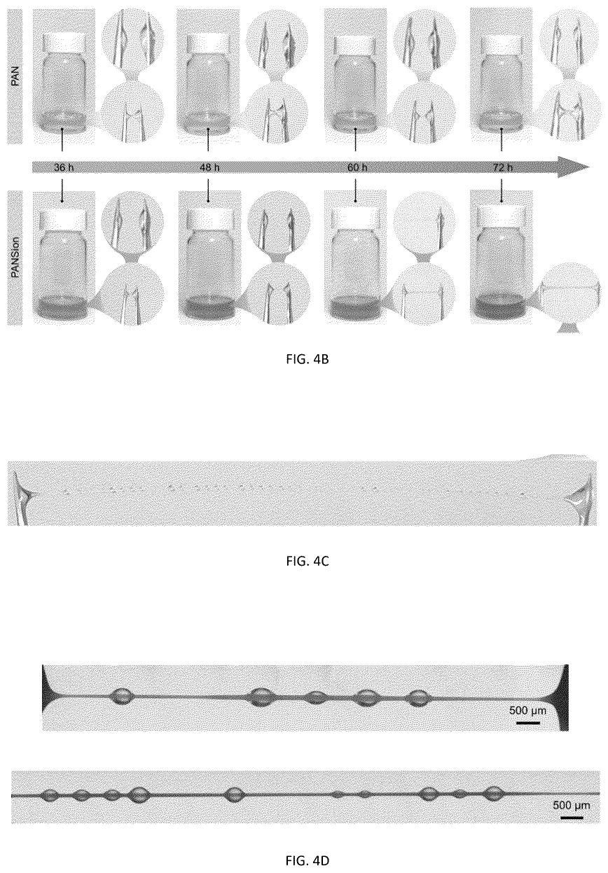

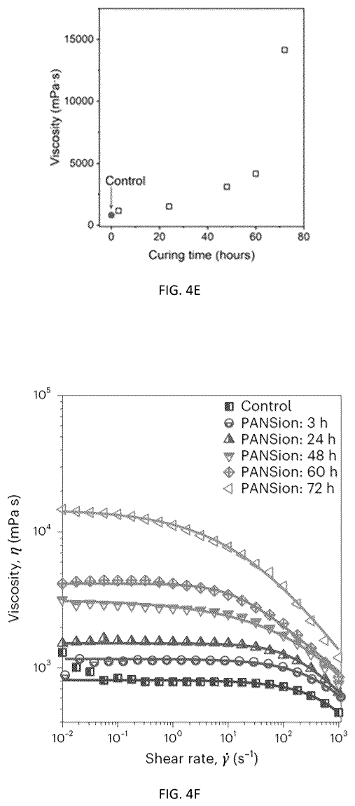

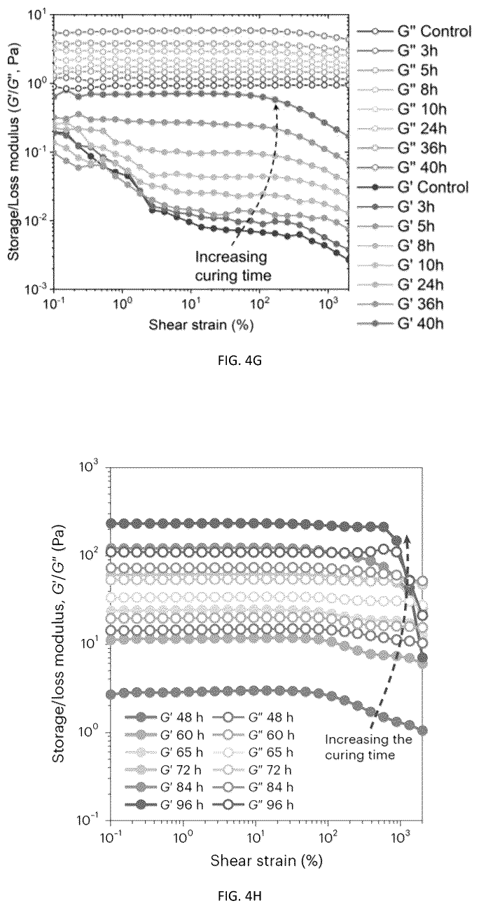

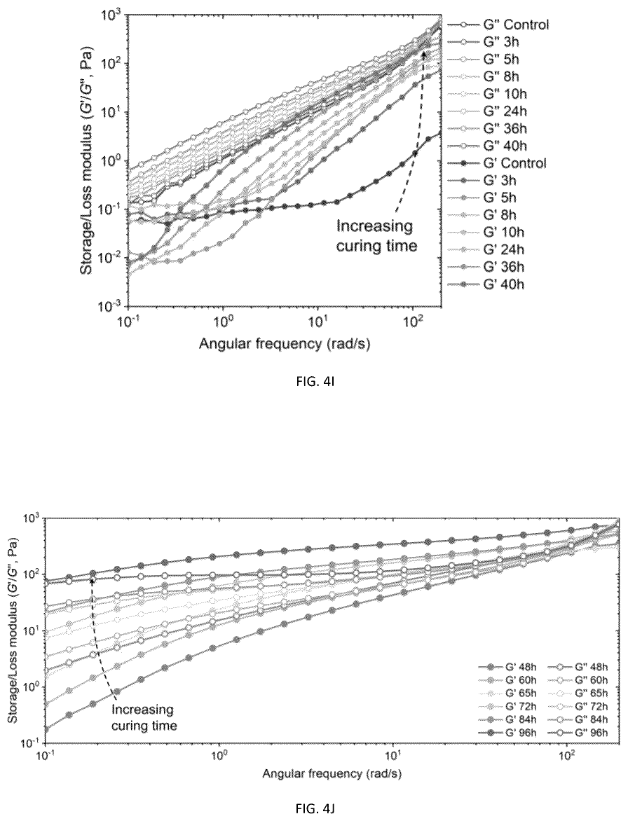

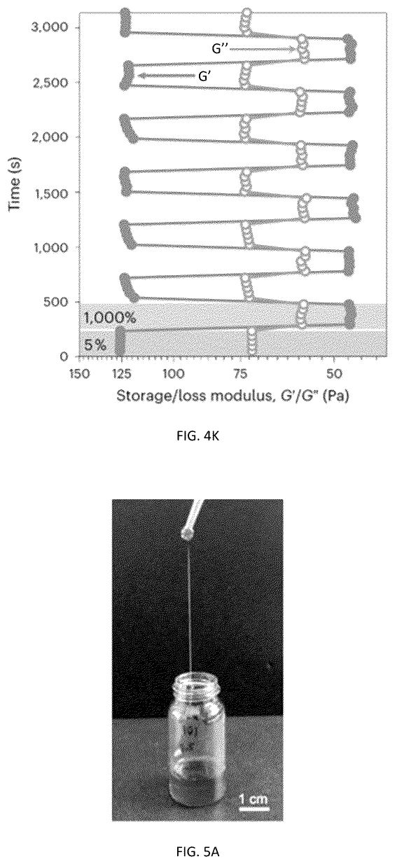

FIG. 4A to FIG. 4D compare the spinnability between polyacrylonitrile (PAN) and polyacrylonitrile-silver ion (PANSion) dopes after 1 to 72 hours of curing at 24° C. in an example embodiment. The viscosity of the PANSion dope was carefully adjusted by controlling the curing time to ensure optimal spinnability. Extending the curing time resulted in a continuous increase in the density of the [Ag(N≡C—)ₓ]⁺ complexes, thereby facilitating the entanglements between neighbouring polymer chains. This hypothesis was supported by the increase in the zero-shear rate viscosity (no) of the PANSion dopes with curing time, up to around 14.6 Pas (of the order of 104 times the viscosity of water) after 72 hours of curing (see FIG. 4E).

The shear-thinning phenomenon (that is, the drop in viscosity at a high shear rate (y)) became more prominent as the curing time was prolonged (see FIG. 4F). This can be explained by the mechanical ruptures of the PANSion molecular entanglements according to the Carreau-Yasuda model. By performing nonlinear fitting to the model, the derived value of relaxation time τ (equal to 1/\dot{γ}_{c}, where \dot{γ}_{c} is the critical shear rate at the onset of shear thinning), was calculated to be about 0.04 s for the PANSion dope, which is characteristic of a viscoelastic shear-thinning fluid.

After curing for 72 hours, the viscoelastic PANSion dope became smoothly spinnable using the PSEA spinning approach. In particular, high viscosity can also be attained for the control of PAN dopes at extremely high concentrations (that is, >20 wt. %). However, without a proper supramolecular network (for example, using [Ag(N≡C—)ₓ]⁺ complexes), these PAN dopes are incapable of forming high-aspect-ratio precursor fibers under ambient conditions, either owing to ductile failure (in high-viscosity solutions) or high local stress and capillarity instability (in low-viscosity solutions).

The mechanical properties of the spinning dope were further characterized by rheological amplitude and frequency sweep tests (see FIGS. 4G to 4J). The as prepared PANSion dope and control PAN dope behaved like liquids; that is, the storage modulus (G′) was much lower than the loss modulus (G″) during amplitude sweeping. Increasing the curing time resulted in a gradual increase in both G′ and G″ for the PANSion dopes. After curing for 72 hours, G′ dominated G″ in the tested amplitude window, with a crossover strain of ˜700% (see FIG. 4H), indicating the typical viscoelastic behaviour of a gel solution.

Additionally, once the crosslinking density reached a critical point (that is, after curing for 72 hours), the yielding strain of the gel dope exceeded 100%, demonstrating the excellent elastic properties of the PANSion supramolecular network. The frequency sweep tests confirmed the successful formation of a stronger PANSion network because G′ was higher than G″ when the frequency was greater than 0.5 rad/s (see FIG. 4J). A decreased frequency dependence was also observed when the curing time was extended: the slopes of the log-log plots decreased for G′ and G″ versus angular frequency. This confirmed the increased inter- or intramolecular chain interactions after the coordination complexes were introduced.

Moreover, the results of the step-strain tests (alternating between 5% and 1000% strains; FIG. 4K) indicated that the PANSion networks underwent fast dissociation-reformation kinetics because of dynamic crosslinkers comprising the [Ag(N≡C—)ₓ]⁺ complexes.

In the example embodiment, the viscosity of a dope is purposely adjusted to achieve good spinnability. For instance, both the concentrations of PAN and silver ions influence the viscosity of the dope and, in turn, the spinnability of the dope. Additionally, curing time also shows significant influence on the spinnability. When extending the curing time at room temperature, a continuous increase of viscosity, storage, and loss modulus via rheological measurements were observed, which confirmed that the formation of [Ag(N≡C—)ₓ]⁺ complex was done. In other words, during the room-temperature curing, the silver-coordinated supramolecular structure gradually grew, forming a strong yet dynamic structure. Consequently, after an appropriate time period of curing at room temperature, the PANSion gel dope became viscoelastic and highly drawable, indicating a good spinnability (see FIG. 4B).

In the example embodiment, as a result of the elastic and dynamic supramolecular PANSion networks, the gel dope was extremely “stretchy” with no capillarity instability or cohesive failure during the mechanical extension under ambient conditions. In other words, the gel dope had excellent spinnability. When producing PANSion fibers via the PSEA spinning approach, a morphology evolution from a precursor gel fiber to a solid one, which was brought about by the NVIPS effect, may be observed (see FIG. 4C).

In summary, a dope, e.g., silver-coordinated polymer gel dope, with an appropriate viscosity assists smooth fiber spinning via the PSEA approach. The strong and dynamic supramolecular network contributes to successful fiber formation under ambient conditions. They help overcome the capillary thinning-out effect and gravitational force drainage that occur in most viscous polymer dopes. Together with the NVIPS effect, the precursor gel fibers progressively strengthen and ultimately transform themselves into solid free-standing fibers once they have been drawn from the dope reservoir into air.

### Spinning of Fibers Under Ambient Conditions

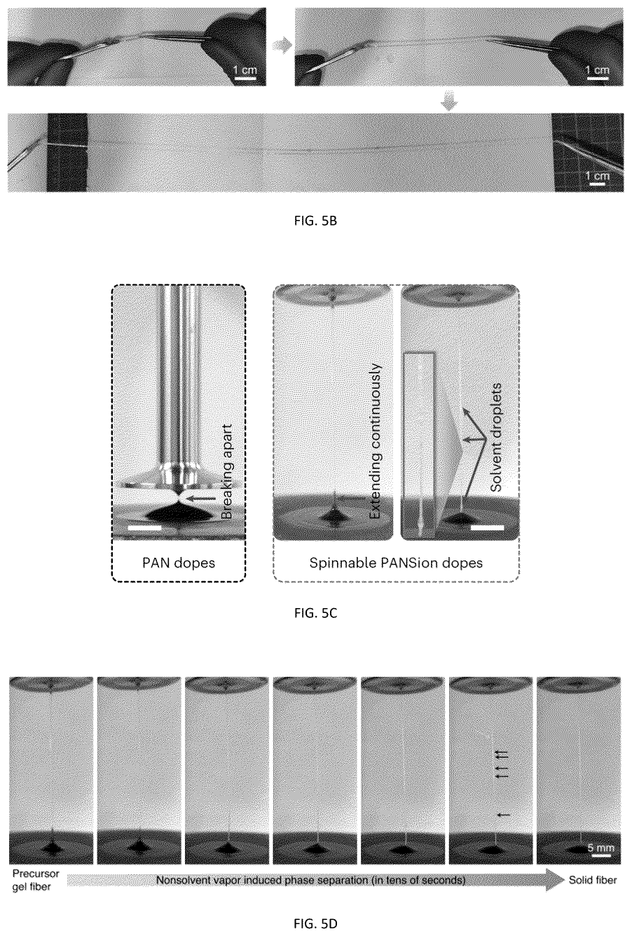

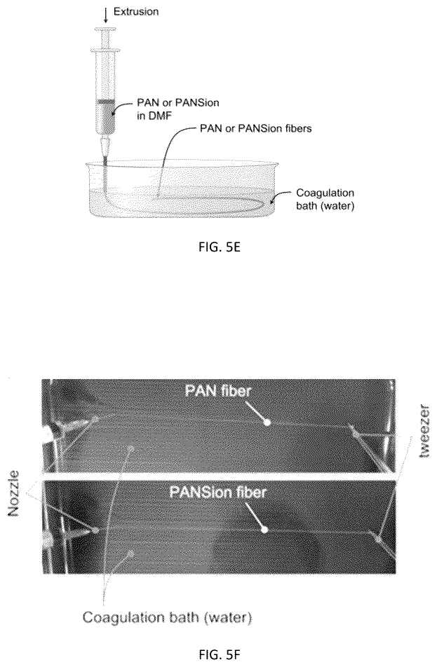

Fiber was directly and manually spun under ambient conditions (75% RH at about 24° C.) from a dope, e.g., gel dope. As shown in FIG. 5A, a PANSion fiber may be spontaneously formed by drawing a thread out of the gel dope. Alternatively, as shown in FIG. 5B, a gel ball may be stretched into a thin thread using two tweezers until a specific diameter was reached. The thread was then horizontally held in air for a few to tens of seconds to allow the phase transition from a gel fiber to a solid fiber. Eventually, the solvent separated from the solute, resulting in liquid-phase droplets on the solid fiber. A solid PANSion fiber was subsequently obtained after vertically holding the fiber or at an incline to allow gravity to remove the solvent droplets.

To facilitate the spinning of fibers under ambient conditions (75% RH at about 24° C.), an ability to form a stable continuous precursor thread in air, and a spontaneous phase transition from a liquid/gel phase to a solid phase under benign conditions, are required in the presently disclosed PSEA spinning approach. To reproduce the silk fabrication process by spiders as closely as possible, external sources such as high temperature, high pressure, coagulation bath, and thermal drying were excluded in the presently disclosed PSEA spinning approach.

By introducing the [Ag(N≡C—)ₓ]⁺ complexes, the modified supramolecular network of spinning dope was strong and dynamic, which led to the stability of precursor gel fibers when being continuously drawn under ambient conditions. In addition, the presently disclosed PSEA spinning approach utilized water molecules from the ambient humidity as nonsolvent to induce the spontaneous phase transition. Consequently, by combining the spinnable gel dope and the NVIPS effect, a biomimetic spinning process can be achieved under room temperature and atmospheric pressure.

It was observed that both PAN and PANSion solutions could undergo phase separation once the solvent composition changed (i.e., in contact with sufficient water molecules). Compared to PAN solution, PANSion dope presented a higher tendency of liquid to solid phase transition under ambient conditions. As shown in FIG. 5C, a network of only PAN molecules is easily broken apart, whereas a PANSion network with silver coordination complexes can continuously deform during axial stretching. As shown in FIG. 5D, phase separation occurred spontaneously once a gel fiber was drawn into air. The continuous supply of water molecules from ambient humidity instantaneously promoted the phase separation once the precursor gel fiber was drawn into air. Liquid droplets (i.e., the mixture of DMF/H₂O) precipitated and then fell off the fiber. Black arrows in FIG. 5D marked the liquid droplets. This confirms that the success of the presently disclosed PSEA spinning approach may be attributed to a spinnable PANSion dope.

Specifically, the origin of phase transition can be interpreted in terms of thermodynamics and polymer chemistry, which have significant influences on the PANSion fiber formation under ambient conditions. From the point of view of thermodynamics, Gibb's free energy of mixing, Gₘ, indicates the compatibility of dissimilar constituents during mixing. The simplified free energy change of the mixture can be written as

$$Δ {G}_{m} = Δ {H}_{m} - T Δ {S}_{m}$$

where ΔHm is the enthalpy of mixing (heat of mixing), and TΔSₘ is the entropy of mixing.

A homogeneous solution (namely, miscible) at the molecular level is only realized at the condition ΔGₘ<0. When the sign of ΔGₘ becomes positive, the thermodynamic driving force for phase separation is generated. For the PANSion dope, the gain in the free energy of mixing due to the entropy Sₘ could be negligible as the polymer chain is sufficiently long. The increased interactions among neighboring PANSion chains after forming [Ag(N≡C—)ₓ]⁺ complexes (i.e., crosslinking) can be viewed as a type of polymerization (note that it can also be regarded as a chemical cooling process), which usually reduces the ΔSₘ term by decreasing the freedom in chemical configurations of molecules, whereas the physical cooling of the system is expressed by the reduction in T. Thus, the TΔSₘ term decreases, and the phase separation is equivalently induced.

Under the conditions of 75% RH at about 24° C., water molecules from the environmental humidity triggered the phase separation of PANSion dope when directly spinning fibers in air. When holding the precursor fiber in air, the solvent precipitated out of the fiber and formed a solvent shell on the fiber's surface. Next, with the gradual accumulation of the solvent, it is eventually broken into separate droplets due to surface tension of tendency for minimizing the interfacial energy. As a result, a solid fiber was obtained by removing the solvent droplets. While phase separation was still ongoing, the elastic stress within the fiber also continuously grew due to the molecular chains' extension, contraction, orientation, and repacking (to balance the capillary pressure), thus becoming sufficiently strong to form a self-supporting fiber (instead of breaking up from the ultimate necking or pinching-off effect). The volume change of the precursor fiber [i.e., diameter, D (t)] can be described with the following equation, which decays exponentially with time:

$$D ( i ) = {( \frac{{η}_{p} {D}_{f}^{4}}{{τ}^{′} σ} )}^{\frac{1}{3}} exp ( - \frac{t}{3 {τ}^{′}} )$$

where D_{f} is the final diameter upon phase separation, ηₚ is the polymer viscosity, and σ is the polymer surface tension. Here, diameter change is expressed in percentage [D(%)] instead of absolute values so that the above equation is modified as follows:

$$D ( \% ) = A exp ( - \frac{t}{3 {τ}^{′}} ) + {D}_{f}$$

This relationship precisely described the experimental data extracted from the optical microscope (OM) images. However, it will be appreciated the dynamic process of PANSion fiber formation is complicated because of the spatially and temporally nonhomogeneous growth of extensional stress, the action of visco-elastic-capillary forces, and the evaporation and diffusion of DMF and water.

For comparison, PAN and PANSion fibers were produced by wet spinning (WS) in a coagulation bath comprising water (see FIGS. 5E and 5F). During WS, the needle was immersed beneath the surface of the water bath. Once the PAN or PANSion fibers were extruded, they immediately came into contact with excess water molecules, resulting in a swift phase transition (unstable spinodal decomposition) from a liquid to a solid. The extruded fibers were soaked in the water bath for a few minutes and then lifted out to dry naturally overnight at 24° C.

For the wet spinning approach, fibers can be readily fabricated for both PAN and PANSion solutions. Once the extruded PAN or PANSion solutions came into contact with the water bath, water molecules (in the liquid phase) were excessive as nonsolvent, resulting in unstable spinodal decomposition. Additionally, the phase separation via wet spinning occurred at a significantly faster rate compared to the presently disclosed PSEA spinning approach.

Consequently, the as-prepared PAN and PANSion fibers via wet spinning (hereinafter referred to as “fibers@WS”) showed different morphologies and properties compared to PANSion fibers via the PSEA spinning method (hereinafter referred to as “fibers@PSEA”). For instance, PAN fibers@WS were with porous structure compared to the solid internal structure of PANSion fibers@PSEA. Noticeably PANSion fibers@WS were less stretchable than that of PANSion fibers@PSEA. Such property differences could also be observed among silk fibers prepared by different approaches: excellent performance when naturally spun by spiders, whereas inferior performance when manually regenerated via a wet-spinning approach. Note that we only used the two cases of PANSion fibers@WS and PAN fibers@WS as demonstrations to showcase our PANSion fibers@PSEA. Therefore, fibers@WS were used as control experiments to manifest the importance of introducing [Ag(N≡C—)ₓ]⁺ complexes to obtain the spinnable PANSion dope, that was suitable for fiber preparation under ambient conditions via our PSEA spinning method.

### Mechanism of Fiber Formation Under Ambient Conditions

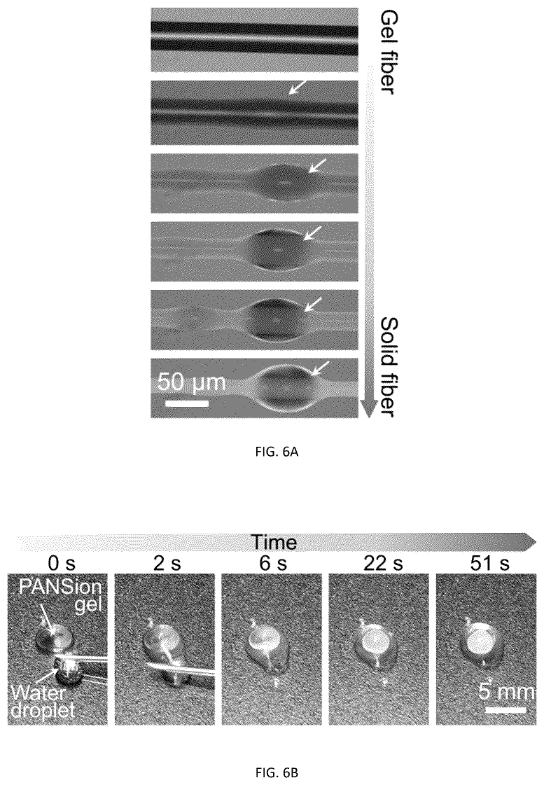

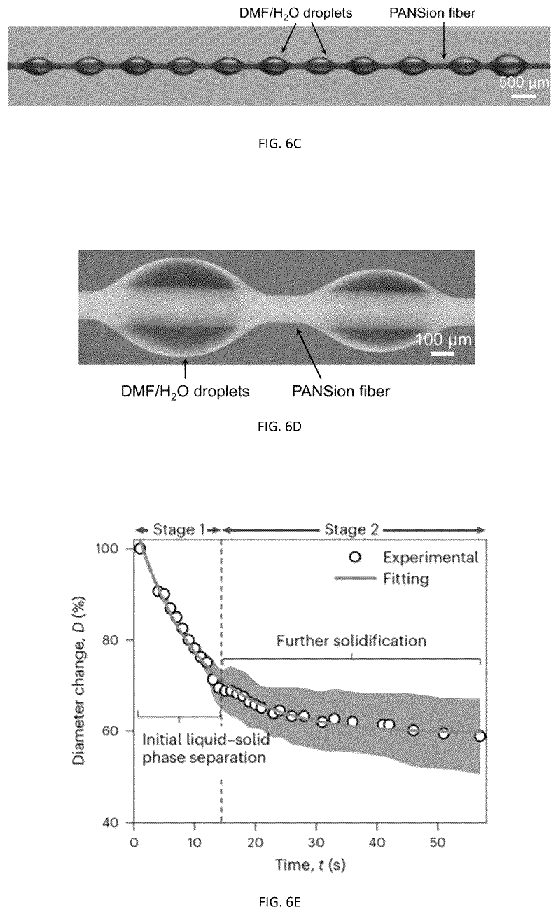

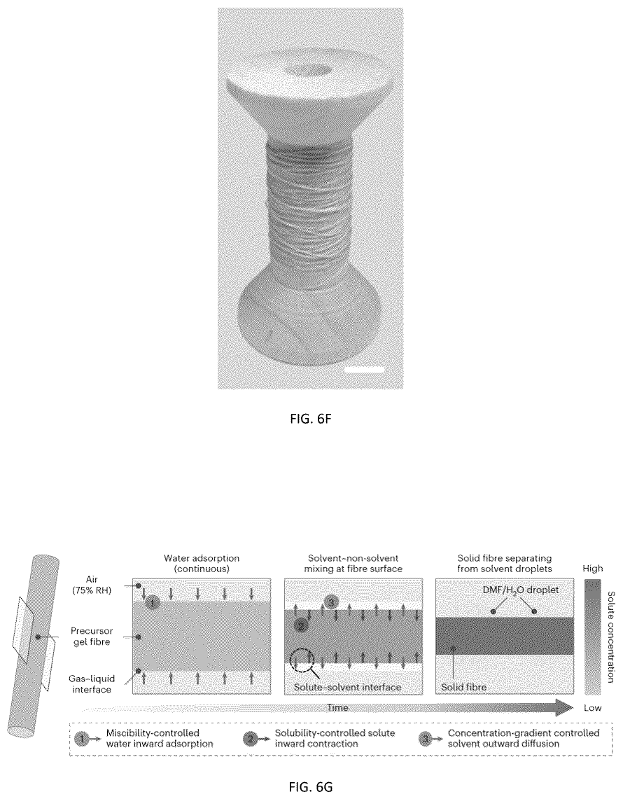

Due to the elastic and dynamic supramolecular network, the PANSion gel dope showed no capillarity instability or cohesive failure during mechanical extension under ambient conditions, meaning it had an excellent ambient condition spinnability. Fiber formation mechanism was investigated, and the results are shown in FIGS. 6A to 6G.

FIG. 6A to FIG. 6D are optical microscopy images showing fiber formation under ambient conditions in an example embodiment. FIG. 6A shows the morphology evolution from a precursor gel fiber into a solid fiber during the PSEA spinning approach facilitated by the NVIPS effect.

Briefly, three stages compete in the spinning process and contribute to the process that triggers fiber formation under ambient conditions: water inward adsorption controlled by the miscibility (with the DMF solvent); solute inward contraction controlled by the solubility (of the PANSion solute); and solvent outward diffusion controlled by the concentration gradient (of the DMF in the fiber radial direction).

As time passed, aqueous DMF solvent precipitated out of a precursor fiber, mixed with water molecules, and eventually accumulated as droplets on the fiber surface (see FIGS. 6C and 6D) as a result of surface tension change in the solvents. Aqueous droplets can be removed (or recollected) by mechanically vibrating or vertically spinning the fibers. Advantageously, this facilitates sustainable manufacturing with solvent recycling capability. Furthermore, the dynamic supramolecular structure of the precursor fiber evolved with sufficient molecular interaction strength as the phase separation continued, and internal elastic stresses continuously grew to resist the pinching or breakup effects caused by capillary action. In other words, upon phase separation, the precursor fiber progressively stabilized itself and radially contracted to a self-supporting solid fiber (see FIG. 6A). Consequently, a PANSion fiber was readily obtained via the PSEA spinning approach under atmospheric pressure and room temperature. To a certain extent, the process resembled the spinning of silk by a spider. Moreover, the fiber length was adjustable and could be extended to meters or an arbitrary scale of fiber length after adopting gel fiber spinning equipment for scaled-up fabrication.

Diameter shrinkage of the precursor fibers during phase separation can be attributed to the viscoelastic capillary thinning effect. However, capillary breakup, which is typical of viscoelastic spinning dopes, did not occur in the precursor fibers because of the supramolecular PANSion network. FIG. 6E shows a profile of the fiber diameter changes using video analysis. The results indicated that the change in fiber diameter was rapid in the initial 10-15 s (that is, the solvent depletion stage). Subsequently, the rate of shrinkage decreased (that is, there was solidification due to polymer chain repacking). The diameter change, D (%), decayed exponentially over time during phase separation, which can be described using the following empirical equation:

$$D ( \% ) = A exp ( - \frac{t}{3 {τ}^{′}} ) + {D}_{f}$$

where D_{f} is the final diameter upon phase separation, t is the time; and A is related to the viscosity, surface tension and relaxation time (τ′) of the spinning dope. As shown in FIG. 6E, the experimental data (unfilled black dots) agreed well with the fitting results (curve line joining the dots, R²=0.99). Furthermore, the characteristic relaxation time obtained from the fitting results (τ′=3.47 s) was almost two orders of magnitude larger than that obtained from the shear rheology measurements (about 0.04 s; Table 2). One possible reason for this is that the precursor PANSion gel fiber became much stronger than the initial gel dope after phase separation when exposed to air.

TABLE 2
Fitting parameters of an empirical model to describe the profile of
fiber diameter change during phase separation

| Equation | $D ( \% ) = A exp ( - \frac{t}{3 {τ}^{′}} ) + {D}_{f}$ |
|---|---|
| A | 46.73039 + 0.97034 |
| D_{f} | 59.50032 + 0.46156 |
| 3τ′ | 10.4002 + 0.42883 |
| Reduced Chi-Square | 1.19503 |
| R-square | 0.99043 |
| Adj. R-square | 0.98974 |

Water molecules facilitate the efficient initiation of phase separation in the precursor gel fibers. For instance, it was observed that water molecules at a relatively low concentration of 25% RH were insufficient to induce the phase transition. In contrast, when in direct contact with a water droplet—the case of excess water molecules—a ball of PANSion gel underwent a rapid phase transition with volume shrinkage, resulting in a soft and compressible solid ball (see FIG. 6B). Therefore, it is possible to use a water coagulation bath to prepare both PAN and PANSion fibers (namely the wet spinning (WS) method shown in FIGS. 5E and 5F). However, both PAN and PANSion fibers produced using the WS method were inferior in terms of mechanical properties or microstructure control because of the unstable spinodal decomposition in the water bath.

Although both PAN and as-prepared PANSion solutions were subjected to phase separation under 75% RH, only the spinnable PANSion gel dope could form a continuous fiber via the PSEA spinning approach. Additionally, in contrast to the unstable phase transition of the WS fibers, the PANSion fibers produced using the PSEA spinning approach underwent a metastable phase transition, which was driven by the mild non-solvent (water-vapour) absorption and solvent (DMF) diffusion at the fiber-air interfaces (namely, the NVIPS effect; see FIG. 6G). It is noted that the addition of silver ions alone to a PAN solution, without continuously supplying water molecules, did not result in phase transitions, indicating the absence of the salting-out effect. The role of the water molecules in the PSEA spinning approach resembles that of the external stimuli present when a spider spins silk, such as acidification or ion flux (see FIG. 2A). Here the water molecules help transform the precursor gel fiber from a liquid-phase to a solid-phase fiber with a well-organized structural architecture.

### Phase Separation Modeling

CG-MD simulation was used to investigate the phase separation process of the precursor PANSion gel fiber under ambient conditions (75% RH, 24° C.). Specifically, a coarse-grained simulation system comprising a nanoscale PANSion thread was created in the shape of a cylinder. The cylinder was periodic in the axial direction and surrounded by water molecules (in the vapour phase), similar to the precursor gel fiber when spun at 75% RH in the experiment. The humidity was controlled by supplying water molecules from a reservoir by implementing a constant-chemical-potential simulation method. Phase separation naturally occurred over time in the CG-MD simulations. A similar approach was conducted for PAN as a control sample.

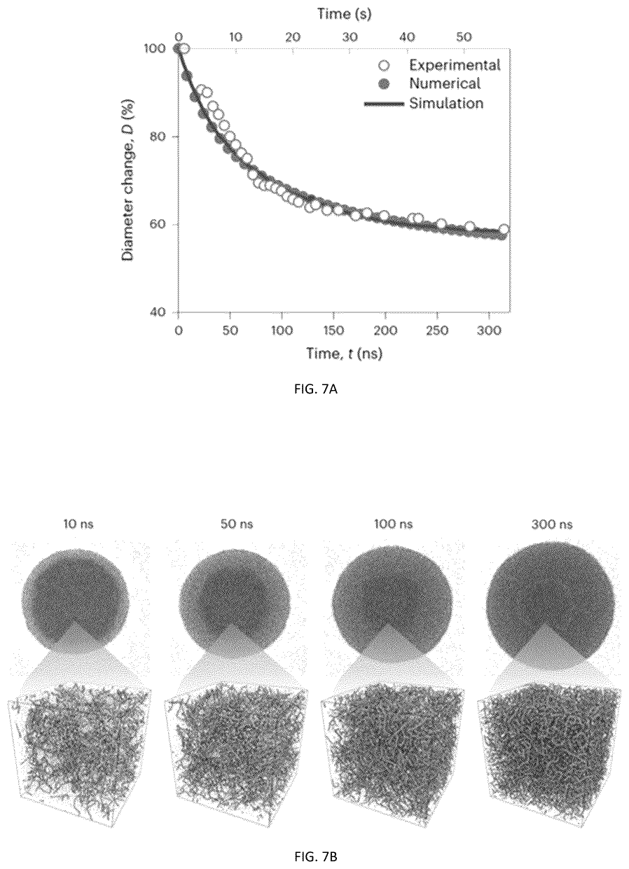

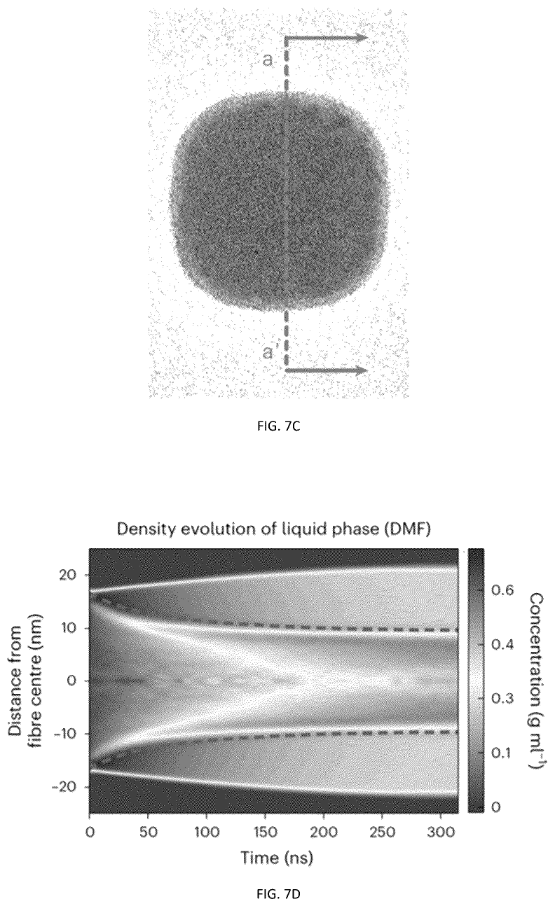

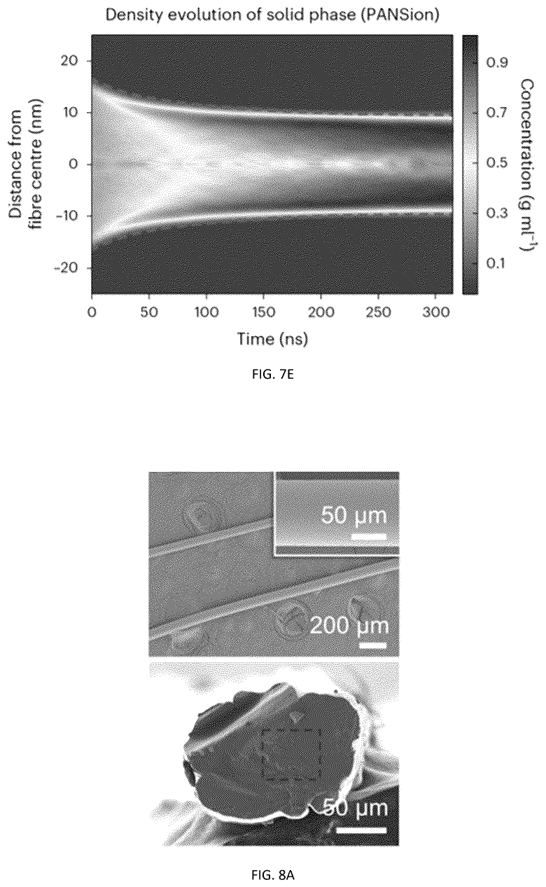

As discussed, the solidification of the precursor gel fiber into a solid fiber is associated with the repacking of the polymer chain network (that is, solute inward contraction), and the concomitant outward mass transfer of DMF (that is, solvent outward diffusion) due to the NVIPS effect. Assuming a constant feeding rate of water molecules at a specific RH level, the changes to the fiber diameter profile during phase separation can be evaluated using the following equations, which are based on the chemical potential differences among the water (non-solvent), DMF (solvent) and PANSion (solute):

$$D ( t ) = \sqrt{1 - {x}^{′} ( t )} \\ and \\ {x}^{′} ( t ) = \frac{{y}^{′} ( t ) {c}^{′}}{1 - {c}^{′} + {y}^{′} ( t )}$$

where c′ is the volume fraction of DMF in the initial precursor gel fiber; x′(t)=V_{DMF}(t)/V_{P}, where V_{DMF}(t) is the volume of DMF transferred outward from the precursor gel fiber to the liquid phase and V_{P} is the initial volume of the precursor gel fiber; and y′(t)=V_{water}(t)/V_{P}, where V_{water}(t) is the volume of condensate water from the air. Note that the outward diffusion mass of the DMF from the precursor gel fiber should be identical to that of the DMF in the liquid phase after phase separation by omitting DMF vaporization under ambient conditions. The calculated results are shown in FIG. 7A (filled dots), and they agree well with the experimental data (unfilled dots). This confirms that the demixing (more specifically, phase separation) between the liquid (DMF) and solid (PANSion) phases resulted in an increase in the density of the supramolecular PANSion network. Consequently, intrachain interactions in the PANSion gradually become sufficiently strong to resist capillary breakup or gravitational force drainage.

The demixing of a precursor gel fiber in a controlled humidity environment was further investigated using coarse-grained molecular dynamics (CG-MD) simulations. At a higher RH level, the phase separation rate was faster. The morphology evolution of the simulated PSEA-produced fibers at 75% RH was fairly homogeneous, producing a final dense structure as time progressed (FIG. 7B). In contrast, the WS-produced fibers had numerous large pores. The temporal and spatial mass changes of both solvent and solute from a unit cross section of the precursor gel fiber are plotted in the longitudinal direction and shown in FIG. 7C-7E (only data from the a-a′ line section is shown). The mapping results demonstrate the features of the experimental phase separation process due to the NVIPS effect, including the diameter change profile, non-solvent absorption, solvent diffusion and increase in the packing density of the solute phase. Solvent outward diffusion was associated with non-solvent (water) absorption, as indicated by the time-resolved DMF concentration evolution (FIG. 7D). Note that the dashed line (FIG. 7D) marks the interface of the liquid/solid phases where the non-solvent/solvent mixture (water/DMF) was immiscible with the remaining solute (PANSion polymer) upon phase separation. The volume of the PANSion network shrank substantially owing to solvent depletion and compact repacking of the supramolecular chains (FIG. 7E), which resulted in a dense structure (FIG. 7B). Additionally, the results from the simulated fiber diameter change (FIG. 7A, curved line) were in line with those from the experimental data and numerical calculations.

### Mechanical and Electrical Properties of Fibers

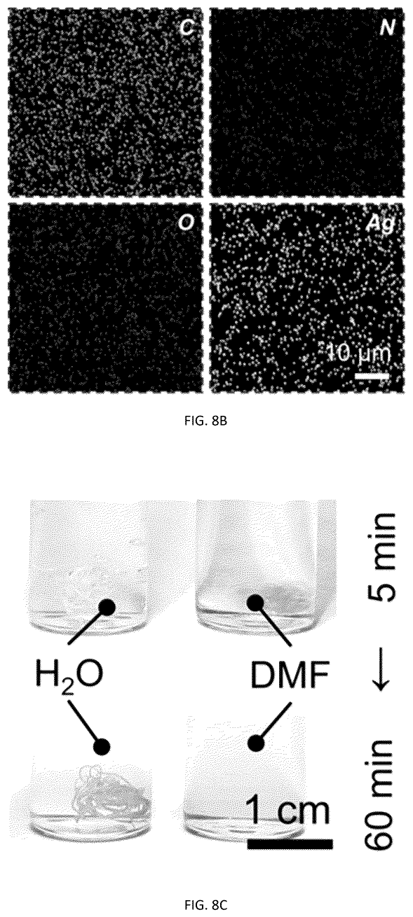

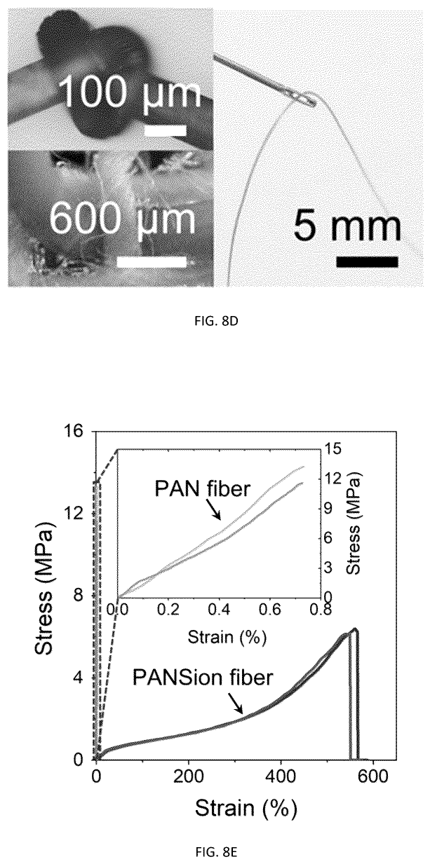

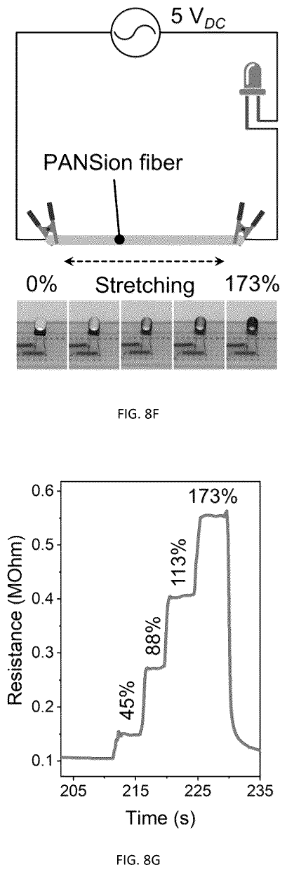

FIG. 8A to FIG. 8G show mechanical and electrical properties of a fiber, e.g., PANSion fiber.

Elemental, surface, and cross-sectional morphologies of the PANSion fibers were investigated by scanning electron microscopy (SEM), as shown in FIGS. 8A and 8B, which reveals a smooth surface, uniform diameter, and solid internal structure. This confirmed the homogenous nature of the metastable phase separation via the PSEA spinning approach, in contrast to the unstable spinodal decomposition via the wet spinning method. For the PSEA spinning method, the metastable phase separation occurred, resulting in a near-homogenous structure. In contrast, unstable decomposition occurred during wet spinning, leading to polymer-rich and nonsolvent-rich regions (i.e., big internal pores). Meters-long PANSion fiber can be obtained with the length decided arbitrarily by adopting a gel fiber spinning equipment to industrial production.

Electrical conductivity of the PANSion fibers is higher than PAN fibers due to the reduction in the in-situ AgNPs by the DMF solvent. The presence of elemental silver was first confirmed from energy-dispersive X-ray mapping results (see FIG. 8B).

Additionally, the PANSion fibers are recyclable (i.e., re-dissolvable in DMF solvent and water-stable (see FIG. 8C). Therefore, the presently disclosed PSEA spinning approach is a sustainable method for fabrication of multifaceted functional soft fibers. Recyclability is important, especially in the era of the Internet of Things (IoT), because it could avoid wastage of soft electronics, and potentially contribute to a sustainable global development. Therefore, the PSEA spinning approach is a sustainable method for the fabrication of multifaceted functional soft fibers.

Furthermore, the PANSion fibers were very soft and stretchable with a failure strain of ˜550% (see FIGS. 8D and 8E). Moreover, their stretchability was unaffected by low temperature quenching, and demonstrated a greater than 700× improvement compared with control PAN fibers produced by wet spinning. The excellent stretchability can be ascribed to the low glass transition temperature (about −25° C.) and the elasticity of the dynamic supramolecular PANSion network.

Lastly, the PANSion fibers showed a strain-hardening feature (maximum strength of about 6.38 MPa), good cyclability, and a strain rate-dependent property (from about 10 to about 1000 mm/min).

Because of their prime conductivity, softness, and stretchability, the fibers can be used as conductors in a circuit to light up a light-emitting diode (LED). It was possible to alter the intensity of the light emitted from an LED by stretching the fibers (see FIGS. 8F and 8G). This may be due to the piezoresistive behavior that results from the percolated conductive network formed by in-situ reduction of the AgNPs. Consequently, a strain sensor comprising the PANSion fibers was able to demonstrate an electromechanical response over a wide strain range with a response time of ˜200 ms (see FIG. 8G).

### Sensing Demonstrations—Smart Fibers and Textile Electronics

To illustrate the potential of PANSion in human-machine interface applications, a commercial knitted glove was used as a substrate into which a PANSion fiber was sewn. A copper wire electrode was attached to each end of the fiber. Signals indicating changes in resistance in the fiber were recorded when a prosthetic hand wearing the smart glove was bent or it approached cold or warm surfaces of various objects. Three hand gestures-rock, paper and scissors-were predefined before the glove was used as a gaming controller for the rock-paper-scissors game. When used as a human-machine interface, signals indicating changes in capacitance from the fingertip area were generated by human finger touches. Subsequently, Morse code was established by converting the dynamic touches (short and long touches) into signals of various duration (dots and dashes).

A sensing mask was enabled by sewing a PANSion fiber into one of the filter layers. Exhaled or inhaled breath generated periodical signals of changes in resistance, by which it was possible to monitor the breathing status.

In the example embodiment, a PANSion fiber may be integrated into a textile as a strain sensor to create an interactive glove for human-machine interface applications (see FIG. 9A). For instance, it was possible to use the bending angle during finger-wagging to control the intensity of the light emitted from an external LED (see FIG. 9B). Alternatively, it was possible to use the signals from finger-wagging, recorded as resistance changes, to control external devices such as the on-and-off switch of an LED (see FIG. 9C). The potential of the interactive textile glove was further exemplified as a smart gaming glove by playing the “rock-paper-scissors” hand game against a computer (see FIGS. 9D and 9E). By wearing the sensing glove, the hand gestures from a human player were successfully detected by monitoring the bending status of the fingers, thereby enabling the representation of “rock”, “paper”, and “scissors”.

PANSion fibers were also responsive to thermal perturbation. This may be due to ion movement being facilitated or constrained at high or low temperatures. Breathing activities, including normal breathing, post-exercise breathing, and obstructive sleep apnea-hypopnea syndrome (OSAHS) were successfully monitored using a sensing mask equipped with a PANSion fiber (see FIG. 9F to 9J). PANSion fibers may be used to convert a common textile into a smart one with various sensing functions using a simple sewing technique. This was facilitated by the excellent softness, strength, and stretchability of the fibers. For instance, a knitted glove equipped with the PANSion fibers was capable of distinguishing between cold or warm objects (see FIGS. 9K to 9M). This feature could be harnessed and functionalized to keep robots safe in complex thermal environments, even before physical contact. Detection of sensing signals was verified by monitoring capacitance changes of a PANSion fiber when in contact with a specific subject, thereby enabling touch recognition, e.g., static and dynamic touch (see FIGS. 9N and 9O). By means of extrapolation, it was possible to exploit static and dynamic touch patterns for cryptographic communication, as exemplified by the Morse code, and remote-controlled human-machine interfacing (see FIG. 9P). In the example embodiment, it was demonstrated that a single PANSion fiber has novel sensing and communication capabilities, and the potential to facilitate the creation of intelligent textiles for versatile human-machine interface applications.

### Applications

Embodiments of the methods disclosed herein provide a method of forming a fiber (e.g., functional soft fiber), a fiber formed by the method, and an article comprising one or more strands of the fiber.

Advantageously, embodiments of the method disclosed herein may be performed under ambient conditions (e.g., 75% relative humidity (RH) at 24° C.). Therefore, embodiments of the method disclosed herein may advantageously overcome the limitations of existing fiber fabrication methods that require complicated fabrication processes, high energy consumption and use of large quantities of solvent, and/or special spinning equipment, which are environmentally and economically costly. Compared to conventional spinning approaches for functional soft fiber production, embodiments of the phase separation enabled ambient spinning approach as disclosed herein only require a relatively small volume of solvent and eliminated the thermal processes, achieving a relatively low energy consumption.

Even more advantageously, the fiber formed from embodiments of the method disclosed herein is highly stretchable, electrically conductive and sufficiently strong. All these features are obtained only via a single step spinning process which cannot be realized via previous methods. Due to the unique combined properties of being stretchable and conductive, the soft fibers formed via embodiments of the presently disclosed PSEA spinning method may find broad application as fiber and textile electronics for tactile sensing, human-machine interfaces, and personal heath monitoring, as well as versatile applications of the fibers as artificial tissues.

It will be appreciated by a person skilled in the art that other variations and/or modifications may be made to the embodiments disclosed herein without departing from the spirit or scope of the disclosure as broadly described. For example, in the description herein, features of different exemplary embodiments may be mixed, combined, interchanged, incorporated, adopted, modified, included etc. or the like across different exemplary embodiments. The present embodiments are, therefore, to be considered in all respects to be illustrative and not restrictive.

1. A method of forming a fiber, the method comprising
preparing a dope comprising a metal ion coordination polymer; and
forming a precursor fiber from the dope in air,
wherein the precursor fiber undergoes a phase transition from a liquid or semi-liquid state to the fiber in a solid state in air.

2. The method according to claim 1, wherein preparing the dope comprises dissolving a polymer resin and a metal ion source in a solvent to obtain a solution of the polymer resin and the metal ion source.

3. The method according to claim 2, wherein preparing the dope further comprises curing the solution of the polymer resin and the metal ion source to obtain the dope comprising the metal ion coordination polymer.

4. The method according to claim 3, wherein the solution of the polymer resin and the metal ion source is cured for a duration falling in the range of from 5 hours to 150 hours at a temperature falling in the range of from 20° C. to 90° C.

5. The method according to claim 3, wherein the solution of the polymer resin and the metal ion source is cured until the dope satisfies one or more of the following conditions:
(i) a viscosity falling in the range of from 10 Pa·s to 50 Pa·s;
(ii) a storage modulus falling in the range of from 100 Pa to 200 Pa; and
(iii) a loss modulus falling in the range of from 10 Pa to 150 Pa.

6. The method according to claim 2, wherein the polymer resin is selected from the group consisting of polyacrylonitrile, poly(methacrylic acid), sodium polyacrylate, acrylonitrile butadiene styrene, and nitrile butadiene rubber.

7. The method according to claim 2, wherein the metal ion is selected from the group consisting of silver, iron, zinc, and bismuth.

8. The method according to claim 2, wherein 5 wt. % to 20 wt. % of the polymer resin is dissolved in the solvent.

9. The method according to claim 2, wherein the metal ion source is provided by dissolving a salt of the metal ion in the solvent.

10. The method according to claim 9, wherein 2 wt. % to 20 wt. % of the salt of the metal ion is dissolved in the solvent.

11. The method according to claim 2, wherein the solvent is selected from the group consisting of dimethylformamide (DMF), N-methyl-2-pyrrolidone (NMP), a mixture of DMF-water, and a mixture of NMP-water.

12. The method according to claim 1, wherein forming the precursor fiber comprises spinning the precursor fiber from the dope.

13. The method according to claim 1, wherein the precursor fiber is formed from the dope in air having atmospheric pressure, a relative humidity falling in the range of from 40% to 95%, and a temperature falling in the range of from 20° C. to 50° C.

14. The method according to claim 1, wherein the metal ion coordination polymer in the dope comprises,
a plurality of metal ions acting as nodes; and
a plurality of organic ligands acting as linkers,
wherein the metal ions are linked to the organic ligands via coordination bonds to form a network structure of the metal ion coordination polymer.

15. The method according to claim 14, wherein the metal ion is silver ion and the ligand is a nitrile group; and wherein the silver ions are linked to the nitrile ligands via coordination bonds to form a [Ag(N≡C—)ₓ]⁺ complex, wherein x is an integer that is no less than 1 and no more than 3.

16. A fiber comprising a metal ion coordination polymer, said metal ion coordination polymer comprising,
a plurality of metal ions acting as nodes; and
a plurality of organic ligands acting as linkers,
wherein the metal ions are linked to the organic ligands via coordination bonds to form a network structure of the metal ion coordination polymer.

17. The fiber according to claim 16, wherein the metal ion is silver ion and the ligand is a nitrile group; and wherein the silver ions are linked to the nitrile ligands via coordination bonds to form a [Ag(N≡C—)ₓ]⁺ complex, wherein x is an integer that is no less than 1 and no more than 3.

18. The fiber according to claim 16, further comprising nanoparticles of the metal interspersed in the network structure of the metal ion coordination polymer.

19. The fiber according to claim 16, wherein the fiber has one or more of the following properties:
an axial strain of at least 500%;
a tensile strength of at least 6 MPa; and
wan electrical conductivity of from 0.1 S/m to 100 S/m.

20. An article comprising one or more strands of fibers formed by the method as defined in claim 1.

21. An article comprising one or more strands of fibers according to claim 16.
